(19) United States
(12) Patent Application Publication
(10) Pub. No.: US 2004/0152502 A1
(43) Pub. Date: Aug. 5, 2004

(54) Gaming machine

(76) Inventor: Kazuo Okada, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/716,138

(22) Filed: Nov. 19, 2003

(30) Foreign Application Priority Data
Nov. 19, 2002 (JP) 2002-335011

(51) Int. Cl. A63F 13/00

(52) U.S. Cl. 463/16

(57) ABSTRACT

A gaming machine is provided with an upper display panel formed by an electric display device so that display contents can be changed. A display panel is comprised of a transparent acrylic plate that is a protective cover, a liquid crystal display device that serves as an electric display device, and a cold-cathode tube that serves as a back light. The amount of media to be paid out that is displayed thereon can be changed with a touch panel provided on a reel display part, and an arbitrary payout table can be selected from among a plurality of payout tables. It is possible to lessen labor required to produce the panel that displays a model name, etc., for each model.

### CROSS-REFERENCE TO RELATED APPLICATIONS

This application is based upon and claims a priority from the prior Japanese Patent Application No. 2002-335011 filed on Nov. 19, 2002, the entire contents of which are incorporated herein by reference.

### FIELD OF THE INVENTION

The present invention relates to a gaming machine and, more particularly, to a gaming machine typified by a slot machine or a “pachinko” machine that includes a variable display means for varyingly displaying various symbols and the function for providing a profit to a player in accordance with a result obtained by controlling and stopping the variable display means.

### RELATED ART

Conventionally, a slot machine can be mentioned as representative of this type of gaming machine. The slot machine includes a plurality of rotational reels each of which has a plurality of symbols positioned on the outer circumferential surface of the reel. When a combination of symbols coincide with a predetermined combination (for example, a state in which symbols identical with each other are aligned) at a stopping state after each rotating reel is stopped, coins or gifts are paid out as winning. In general, types of contingency are often involved in winning, so that a game result cannot be completely controlled only by the skill of a player. The slot machine is greatly characterized by being provided with an element of randomness.

There are various methods to realize this randomness. The most recent, dominant method is a control method called “pre-determination” in which a software-based lottery process for winning is operated by use of a microcomputer, and according to a lottery result, the stopping control of reels is performed. For example, a slot machine disclosed in Japanese Patent Publication of Examined Application No. Hei03-72313 is concerned with a slot machine provided with stop buttons which is a so-called pachi-slot gaming machine or a pinball-style slot machine. This pachi-slot gaming machine includes a random-number sampling means for sampling a random number in accordance with the start-lever operation of a player and a winning probability table in which the range of random number is divided into sub-ranges of “big hit,” “mid hit,” and “small hit” in accordance with the magnitude of a winning combination. When the value of sampled random number is included in a winning division of the winning probability table, the winning combination is determined, and a hit (winning) flag of this winning combination is formed. The following two examples can be mentioned as this type of winning combination. One is a winning combination, called “small winning combination,” according to which about ten coins are paid out when predetermined symbols (e.g., “bell” symbols or “cherry” symbols) are aligned on a activated pay line. The other is a winning combination, called “bonus winning combination,” which is formed when predetermined symbols (e.g., “7” symbols or “BAR” symbols) are displayed, which creates a situation where winning is more easily generated during a fixed number of games than a situation where an ordinary game is played, and by which a large number of approximately 100 to 400 coins are paid out.

A state where a winning flag has been formed is generally called an “internal winning” state. In this state, a winning combination of symbols corresponding to this flag are only permitted to be aligned on the pay line, but winning has still not been actually generated. In order to generate the winning, there is a need to operate the machine at a timing (normally, four segments or less) at which winning symbols being rotated can be stopped on the pay line, in other words, there is a need to perform a so-called “observation push.” If this operation timing is bad, winning will not be generated, in other words, a so-called “missed winning” will be generated in spite of the fact that internal winning has been established. The term “observation push” refers to carrying out the stopping operation by carefully observing each of the reels so as to have desirable symbol(s) on a pay line.

From an overall viewpoint, it can be said that this missed winning is a failure in the observation push. The cause thereof has some patterns. First, a pattern exists in which, although symbols to be targeted are predetermined, changing symbols cannot be recognized, and a failure occurs resulting from a rough stopping operation. Second, a pattern exists in which there are two or more winning combinations having the possibility that internal winning will be generated in the present game, and a player cannot perform a stopping operation while targeting one of the symbols, so that a failure occurs resulting from a rough stopping operation.

Concerning the former, accuracy can be expected to be improved by enabling the player to become skillful in the technique of the observation push. Concerning the latter, however, accuracy cannot be expected to be improved even if the player is skillful in the observation push, because there is a need to understand the state of internal winning which is invisible to the eye.

Conversely speaking, so long as an internal-winning combination is notified, it is possible to create a game situation like a bonus game in which a large number of coins can be obtained even if it is in an ordinary game situation. There is a gaming machine provided with a function that is commonly called “assist time” in which the number of missed winnings is reduced, and a large number of coins are paid out, in comparison with an ordinary game, by notifying not only the acquisition of internal winning but also the kind of internal-winning combination during a predetermined period of time when a predetermined condition is satisfied. The “assist time” is using a game characteristic unique to the pachi-slot gaming machine. According to the classification of game situations described later, this belongs to a payout during a general game, and the amount of coins paid out can be configured to match the amount for a bonus game.

There is also a function “super time” that changes the amount of coins paid out based on whether winning of internal winning combination is supported or not. For the super time, a plurality of “stopping tables” are provided. Each of the stopping tables specifies how many segments are to be moved and stopped from the position of a stopped symbol when rotating reels are controlled and stopped by a player operating a stop button. A stopping table is determined by a random-number lottery whenever a winning combination obtains internal winning. If a stopping operation is not performed according to the order of the stopping operation specified by the determined stopping table, stopping control that does not generate winning will be performed even if the timing of an observation push is appropriate. Like the aforementioned “assist time” function, a large amount of coins that match those of a bonus game can be paid out by providing a state of informing the kind of a selected stopping table and a state of not informing the kind thereof herein.

For example, if three stop buttons are provided, i.e., a left-reel stopping button, a center-reel stopping button, and a right-reel stopping button, six kinds of stopping tables are prepared as follows: “Left stop, center stop, right stop,” “left stop, right stop, center stop,” “right stop, left stop, center stop,” “center stop, right stop, left stop,” and “center stop, left stop, right stop,” in order of operations. Winning is not generated if operations are not performed according to instructions specified by a stopping table whose kind has been determined by the random-number lottery.

In an actual game, switching is performed according to a game situation at that time between a special game situation in which the probability of winning becomes higher than a general game and a general game situation in which a special game situation does not occur.

Actually, in order to pay out coins to a player, symbols of predetermined winning combination are required to be stopped and displayed on a pay line. A general gaming machine has a plurality of winning aspects differing in the amount of media (e.g., the number of coins) to be paid out. For example, there are a “cherry” winning combination and a “bell” winning combination which belong to a small winning combinations, and a “big bonus” winning combination which belongs to a bonus winning combination.

The amount of media to be paid out is set for each winning combination. Japanese Unexamined Patent Publication No. 1997-261972 discloses a slot machine in which the number of media to be paid out is displayed as a payout table on a display panel so that a player can visually check it. The display panel is formed by laying a light-transmittance cell sheet upon a transparent acrylic plate. On the cell sheet, winning symbols, the number of media to be paid out, etc., are displayed by printing. Printed items are illuminated with light, for example, of a fluorescent lamp from the inside a gaming machine.

A general slot machine has a plurality of display panels. For example, the slot machine includes a reel display panel that has a display window part at its center and through which a player can visually discern reels disposed inside the gaming machine, an upper panel that is disposed above the reel display panel and that is formed by a panel relatively smaller in size than the reel display panel, and a lower panel that is disposed below the reel display panel and on which a model name, a character used as a symbol of the pachi-slot gaming machine, etc., are drawn.

From the viewpoint of production efficiency and costs, a general pachi-slot gaming machine uses a shared member between a cabinet and a front door. The display panels, on which illustrations and decorations relating to a theme of the gaming machine are provided, fulfill a role of externally differentiating the gaming machine from other gaming machines.

The display panels of a machine model have decoration provided differently from those of another machine model. Therefore, if products of a particular machine model remain unsold, the display panels of these products will be left as useless goods in stock because, unlike the cabinet or the front door body, the display panels cannot be diverted for use in other products.

Furthermore, there is a need to employ a step of mounting a display-panel unit on a front door when a product is constructed, and therefore the number of manufacturing steps increases.

As a countermeasure to this problem, a proposal has been made to produce a gaming machine in which these display panels are formed by an electric display device like a liquid crystal display device and, in order to display different symbols, an image ROM on which image data is stored is exchanged with another one so as to reduce costs. A specific problem does not arise when an object is set up to chiefly exhibit originality in decoration, for example, by changing characters or title logos. However, when a payout table, for example, is changed, there is a need to change control parameters of the gaming machine as well as the payout table, because a change in the number of media to be paid out affects the payout rate of the gaming machine.

It is therefore an object of the present invention to provide a gaming machine capable of solving the problem of dead stock resulting from the fact that a display panel of a product differing from that of another product is manufactured and capable of being adjusted to various specification changes by forming a structure in which control parameters in the gaming machine can be adjusted in response to a change in display contents.

### SUMMARY OF THE INVENTION

According to the present invention the following may be provided.

(1) A gaming machine comprising: a plurality of reels for variably displaying each of a plurality of symbols thereon; an image display device for displaying an image that differs from the symbols of the reels; a payout device for payout; a controller for executing a predetermined program and controls the reels, the image display device, and the payout device, wherein the controller operates a lottery of a winning combination according to the predetermined program; the controller controls and stops a changing display of the reel based on the winning combination obtained by the lottery; the controller allows the payout on the basis of an amount of payout set to the winning combination when a stop mode of the reel matches a symbol combination of the winning combination; and the controller allows the image display device to display the winning combination and the amount of payout while changing the amount of payout.

In the present invention, the upper display panel situated above a reel display panel is formed by an electric display device, on which a payout table is displayed. The payout table displayed thereon can be changed by a predetermined operation of a manager for managing a gaming machine (hereinafter, referred to as “manager”).

According to this structure, it is possible to minimize the problem of dead stock resulting from the fact that the display panel is formed by physical acrylic plates and symbol cell sheets and the problem of an increase in the number of assembly steps. Additionally, since display contents can be changed afterward, a flexible change can be made in accordance with the business policy of an individual game arcade.

(2) The gaming machine according to claim 1, wherein the image display device is formed by an electric display device and displays an image with reference to the changed amount of payout.

In an embodiment described later, the payout table is displayed on the upper display panel formed by a liquid crystal display device disposed above the reel display panel, and a changing operation performed by a game manager is reflected in display contents.

According to this structure, payout display panels do not need to be individually produced when a payout rate in the present state is changed, and therefore various payout tables can be made only by changing image data. Additionally, since the structure is formed so that the data can be set from the outside even after a product is completed, a detailed setting can be made according to the convenience of a game arcade.

(3) The gaming machine according to claim 1, wherein the controller operates in a plurality of operating modes changing the amount of payout.

(4) The gaming machine according to claim 3, wherein at least one of the operating modes changes the probability of the lottery.

(5) The gaming machine according to claim 4, wherein at least one of the operating modes changes the probability of the lottery for a bonus winning combination.

(6) The gaming machine according to claim 1, wherein the controller has a plurality of kinds of payout data, and applies one kind of the payout data based on a selecting operation of a manager for managing the gaming machine.

In payout changing, a payout-rate setting screen in which the amount of media to be paid out and an internal-winning probability are set concerning all winning combinations is displayed on the reel display panel. A plurality of payout-rate setting screens are prepared, and an arbitrary payout rate (i.e., the number of media to be paid out and internal-winning probability) can be selected by a selecting operation.

According to this structure, it is possible to prevent the troublesome job of individually setting the amount of payout concerning each winning combination, and the payout table can be relatively easily changed.

(7) The gaming machine according to claim 1, wherein the controller also authenticates effectiveness of a password inputted by an operation of a manager for managing the gaming machine, and changing the amount of payout on the basis of a result of the authentication means.

According to this structure, only a specific person who knows the password can change the amount of payout. Therefore, a person who can change the number of media to be paid out is restricted to game manager or a game arcade attendant, thus preventing a player from illegally changing it.

(8) A gaming machine comprising: variable display means for variably displaying a plurality of symbols; lottery means for operating a lottery of a winning combination; stopping control means for controlling and stopping the variable display means on a basis of a result of the lottery; payout means for payout on the basis of an amount of the payout set for the winning combination when a stopped state of the variable display means reaches a symbol combination equal to the winning combination; payout display means for displaying the winning combination and at least the amount of payout to be paid out; and payout changing means for changing the amount of payout.

Herein, the variable display means is, for example, a reel on which symbols are positioned. The payout paying means is comprised of, for example, a hopper drive circuit 113, a payout device through a hopper 114, and a microcomputer 102. The payout display means is, for example, an upper display panel 6.

Other features and advantages of the present invention will be apparent from the following description taken in connection with the accompanying drawings.

### BRIEF DESCRIPTION OF THE DRAWINGS

FIG. 1 is a perspective view that shows the exterior of a pachi-slot gaming machine of an embodiment.

FIG. 2 is a sectional view of a front door.

FIG. 3 is a block diagram that shows a main control circuit.

FIG. 4 is a block diagram that shows a sub-control circuit.

FIG. 5 is a block diagram that shows an image control circuit.

FIG. 6 is a view that shows each display panel.

FIG. 7 is a view that shows pay lines.

FIG. 8 is a view that shows reels and back lamps.

FIG. 9 is a view that shows symbol trains shown on outer circumferential surfaces of reels.

FIG. 10 is a view that shows the symbol combination and the number of media to be paid out for each winning combination.

FIG. 11 is a view that shows stopping tables selected when the bell of the winning combination obtains internal winning.

FIG. 12 is a view that shows a winning probability table.

FIG. 13 is a view that shows a list of commands transmitted to the sub-control circuit.

FIG. 14A is an enlarged view of a reel display panel.

FIG. 14B is an enlarged view of a reel display panel.

FIG. 14C is an enlarged view of a reel display panel.

FIG. 15 is an enlarged view of a reel display panel.

FIG. 16A is a view that shows an effect screen during a super time game.

FIG. 16B is a view that shows an effect screen during a super time game.

FIG. 16C is a view that shows an effect screen during a super time game.

FIG. 17A is a view that shows an effect screen during the super time game.

FIG. 17B is a view that shows an effect screen during the super time game.

FIG. 17C is a view that shows an effect screen during the super time game.

FIG. 18A is a view that shows a prediction effect screen.

FIG. 18B is a view that shows a prediction effect screen.

FIG. 18C is a view that shows a prediction effect screen.

FIG. 19A is a view that shows a prediction effect screen.

FIG. 19B is a view that shows a prediction effect screen.

FIG. 20 is a view that shows a BR generation and BR continuation number lottery table.

FIG. 21A is a view showing a prediction effect generation table.

FIG. 21B is a view showing an effect-kind selection table.

FIG. 22A is a view that shows a support menu.

FIG. 22B is a view that shows a password input screen.

FIG. 23 is a view that shows a payout-rate setting screen.

FIG. 24 is a view that shows a payout-rate setting screen.

FIG. 25 is a view that shows a payout-rate setting screen.

FIG. 26A is a view that shows a payout table.

FIG. 26B is a view that shows a payout table.

FIG. 27 is a flowchart that shows the processing of the main control circuit.

FIG. 28 is a flowchart that shows the processing of the main control circuit.

FIG. 29 is a flowchart that shows the processing of the main control circuit.

FIG. 30 is a flowchart that shows an initializing process.

FIG. 31 is a flowchart that shows an interrupt process 1.

FIG. 32 is a flowchart that shows a sub-side main process.

FIG. 33 is a flowchart that shows a parameter changing process.

FIG. 34 is a flowchart that shows a parameter changing process.

FIG. 35 is a flowchart that shows a payout/probability changing process.

FIG. 36 is a flowchart that shows a payout/probability changing process.

FIG. 37 is a flowchart that shows an input process.

FIG. 38 is a flowchart that shows an effect control process at the start.

FIG. 39 is a flowchart that shows a BR generation lottery process.

FIG. 40 is a flowchart that shows a BR execution process.

FIG. 41 is a flowchart that shows an effect control process when reels are stopped.

FIG. 42 is a flowchart that shows an effect control process when one game is ended.

FIG. 43 is a flowchart that shows a prediction effect generation process.

FIG. 44 is a flowchart that shows a parameter updating process.

### PREFERRED EMBODIMENTS OF THE INVENTION

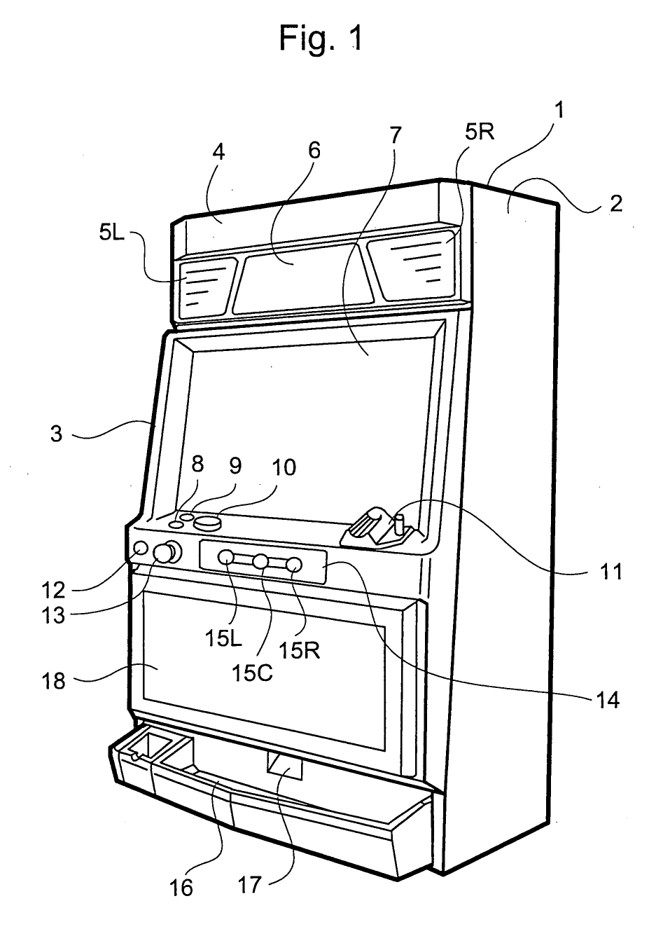

FIG. 1 is an external view of a slot machine provided with stop buttons, called a pachi-slot gaming machine, which is an embodiment of a gaming machine according to the present invention. A front door 3 is attached, in a manner enabling opening and closing, to a plywood, box-shaped cabinet 2 of a pachi-slot gaming machine 1. Above the front door 3, there are provided a game-situation display lamp 4 that blinks when a bonus game or an error occurs, speakers 5L and 5R that output an effective sound or an error sound, and an upper display panel 6 that displays the number of media to be paid out for each winning combination and a brief description of a game. Inside the upper display panel 6, there is a liquid crystal display device that displays various data based on data concerning the number of media to be paid out for a winning combination and other data stored in a ROM. A substantially vertical reel display panel 7 is provided at the center of the front door 3.

A 1-BET switch 8, a 2-BET switch 9, and a MAX-BET switch 10 are provided at the lower left of the reel display panel 7. Under the condition where coins are credited (that is, reserved) to the pachi-slot gaming machine 1, one coin can be bet on a game at once by pushing the 1-BET switch 8. Two coins can be bet on a game at once by pushing the 2-BET switch 9. Three coins, which are the maximum number at a one-game bet, can be bet on a game by pushing the MAX-BET switch 10 once. A predetermined pay line is activated by operating these BET switches. A coin insertion slot 11 through which a coin is inserted is provided at the lower right of the reel display panel 7.

At the left of the center of the front door 3, there is provided a credit/payout (C/P) switch 12 that is pushed to determine whether coins obtained by a player who has won a game are credited or paid out. Coins are paid out through a coin return opening 17 by pushing the C/P switch 12 for switching. Coins paid out are accumulated on a coin tray 16. At the right of the C/P switch 12, a start lever 13 is provided rotatably within a predetermined angular range. When a player operates the start lever 13, reels disposed inside the reel display panel 7 start rotating, and symbols are variably displayed.

At the center of the front door 3, there is provided a stopping operation part 14 that serves as a stopping means and that stops the rotating reels. The stopping operation part 14 includes a left stop button 15L, a center stop button 15C, and a right stop button 15R. A player can arbitrarily determine the order in which the stop buttons 15L, 15C, and 15L are stopped. Generally, a stopping operation performed when all reels are rotating is called “first stopping operation.” A stopping operation performed subsequently thereto is called “second stopping operation,” and a stopping operation performed lastly is called “third stopping operation.” In this embodiment, an operation of the left stop button 15L as the first stopping operation is called “sequential push.” Likewise, an operation of the center stop button 15C as the first stopping operation is called “center push,” and an operation of the right stop button 15R as the first stopping operation is called “backward push.”

A gaming machine including three stop buttons has six kinds of stopping operation orders in total. Operating of an operation of the left stop button 15L as the first stopping operation, an operation of the center stop button 15C as the second stopping operation, and an operation of the right stop button 15R as the third stopping operation is called a “left-center-right push.” Operating of an operation of the center stop button 15C as the first stopping operation, an operation of the left stop button 15L as the second stopping operation, and an operation of the right stop button 15R as the third stopping operation is called a “center-left-right push.” Operating of an operation of the center stop button 15C as the first stopping operation, an operation of the right stop button 15R as the second stopping operation, and an operation of the left stop button 15L as the third stopping operation is called a “center-right-left push.” Operating of an operation of the left stop button 15L as the first stopping operation, an operation of the right stop button 15R as the second stopping operation, and an operation of the center stop button 15C as the third stopping operation is called a “left-right-center push.” Operating of an operation of the right stop button 15R as the first stopping operation, an operation of the left stop button 15L as the second stopping operation, and an operation of the center stop button 15C as the third stopping operation is called a “right-left-center push.” Operating of an operation of the right stop button 15R as the first stopping operation, an operation of the center stop button 15C as the second stopping operation, and an operation of the left stop button 15L as the third stopping operation is called a “right-center-left push.”

Below the stopping operation part, there is provided a lower display panel 18 that displays the title of the pachi-slot gaming machine 1, images of appearing characters, etc. Inside the lower display panel 18, there is provided a liquid crystal display device in which effect control is imposed on various images based on image data stored in a sub-control circuit described later.

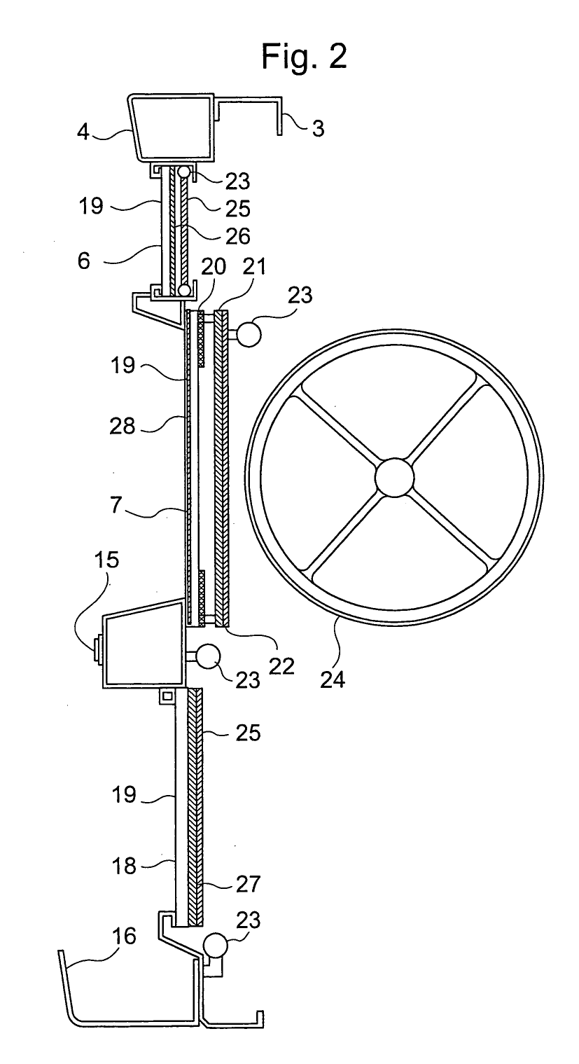

FIG. 2 is a sectional view of the front door 3 of the pachi-slot gaming machine 1. The front door 3 includes three display panels, i.e., includes, from above, an upper display panel 6, a reel display panel 7, and a lower display panel 18, each of which makes a display in accordance with title logos, characters, and game situations. The reel display panel 7 includes a touch panel 28 that detects a coordinate position touched by a player, a picture sheet 20 made of a transparent film on which various pictures are printed, a reel-part liquid crystal display device 21 that is a transparent liquid crystal display device like ITO, and an electronic shutter 22 made of, for example, a liquid crystal film. The picture sheet 20, the reel-part liquid crystal display device 21, and the electronic shutter 22 are laminated inside a transparent acrylic plate 19 used as a protection cover. Cold-cathode tubes 23 used for back light illumination of the reel-part liquid crystal display device and for illumination of symbols drawn on a reel 24 are disposed at the inside lower part and the inside upper part, respectively, of the reel display panel 7. Among display elements, pictures drawn on the picture sheet 20 are always visually discerned by a player without being influenced by the effect control state of the pachi-slot gaming machine 1. The reel-part liquid crystal display device 21 occupies a display area for image effects, such as a big-hit effect and various prediction effects. According to voltage to be applied, the electronic shutter 22 performs switching between passing (or transmission) and blocking (or shielding) in a predetermined area. In other words, an effect executed by the reel-part liquid crystal display device 21 can be switched between an ordinary display (a state in which only the effect display can be visually discerned by allowing the electronic shutter 22 to block the reel 24) and a semitransparent display (a state in which symbols of the reel 24 disposed behind can be visually discerned through the effect display) in response to switching between a state in which symbols of the reel 24 can be visually discerned and a state in which symbols of the reel 24 cannot be visually discerned, through the reel display panel 7.

The upper display panel 6 is provided above the reel display panel 7. The upper display panel 6 is comprised of, inside the transparent acrylic plate 19 used as a protection cover, an upper liquid crystal display device 26, the cold-cathode tube 23 that serves as a back light source, and a light guiding plate 25 that spreads light emitted from the cold-cathode tube 23 over the entire liquid crystal display device.

The lower display panel 18 is provided below the reel display panel 7. The lower display panel 18 is comprised of, inside the transparent acrylic plate 19 used as a protection cover, a lower liquid crystal display device 27, the cold-cathode tube 23 that serves as a back light source, and a light guiding plate 25 that spreads light emitted from the cold-cathode tube 23 over the entire liquid crystal display device.

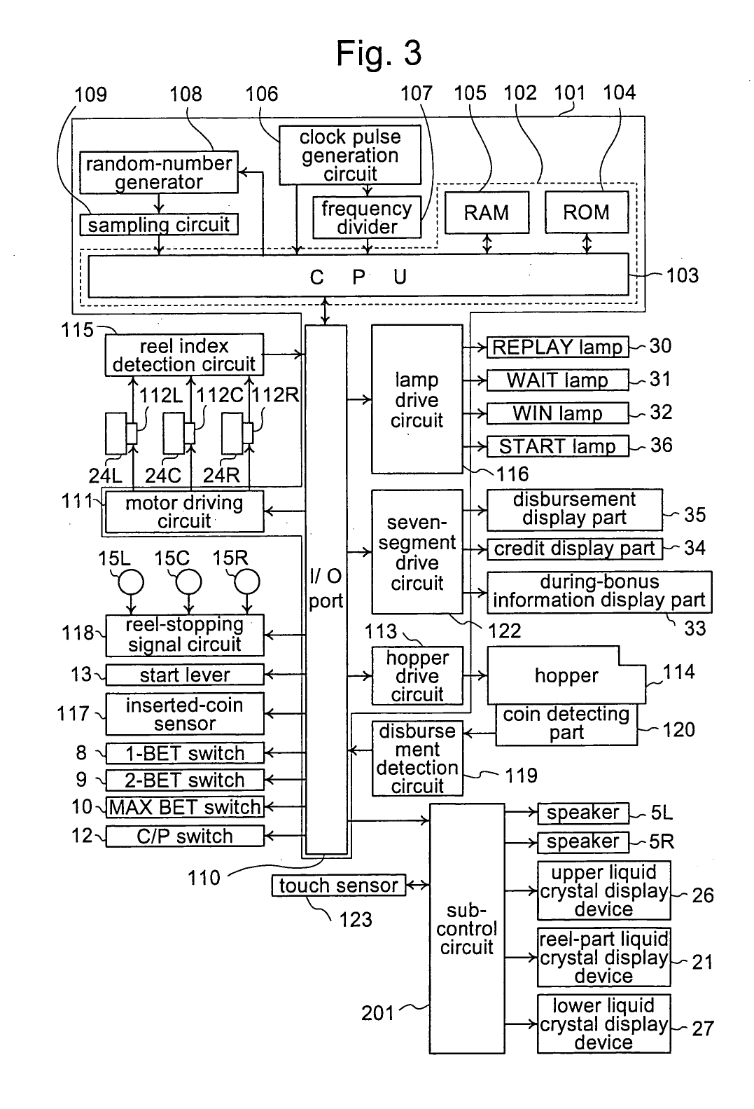

FIG. 3 is an example of a circuit block diagram to realize the operation of the pachi-slot gaming machine 1 shown in FIG. 1. A game control means in this embodiment is made up chiefly of two control circuits. A main control circuit 101 controls various peripheral devices electrically connected together, based on input signals transmitted from various detection means. A sub-control circuit 201 controls effect images displayed on various liquid crystal display devices and effective sounds emitted from the speakers 5L and 5R, based on game information transmitted from the main control circuit 101 and based on the operational input from the touch panel 28 disposed on the reel display panel 7.

The main control circuit 101 is comprised of a microcomputer 102, which is a main constituent element of the control circuit 101, disposed on a circuit board and circuits used for random-number sampling. The microcomputer 102 includes a ROM 104 in which a game program and data are prestored, a CPU 103 that performs a control operation in accordance with the game program of the ROM 104, and a RAM 105 that provides a work area required for a control process. Various means of the present invention are formed by the CPU 103. Processes of various means are executed by allowing the CPU 103 to control the operation of each peripheral device in accordance with the game program.

A clock pulse generation circuit 106 that generates a reference clock pulse, a frequency divider 107, a random-number generator 108 that generates random numbers, and a sampling circuit 109 that samples random numbers based on signals transmitted from a start lever 13 described later are connected to the CPU 103. As means for random-number sampling, the microcomputer 102 may perform random-number sampling through software processing. If so, the random-number generator 108 and the sampling circuit 109 can be omitted.

The ROM 104 of the microcomputer 102 stores a control program to control various operations of the pachi-slot gaming machine. The ROM 104 stores a winning probability table used to determine the suitability of a random-number value obtained on the basis of the operation of the start lever 13 in a probability lottery process described later, a stopping table that determines the position where the reels 24L, 24C, and 24R are stopped in response to the operation of the stop buttons 15L, 15C, and 15R, various game information commands issued to the sub-control circuit 201, etc. Various peripheral devices are connected to the CPU 103 through an I/O port 110.

A motor driving circuit 111 drives and controls stepping motors 112L, 112C, and 112R that rotate and drive the reels 24L, 24C, and 24R, respectively, in accordance with a driving signal transmitted from the CPU 103. The motor driving circuit 111 stops and controls the stepping motors 112L, 112C, and 112R in accordance with a stopping control signal transmitted from the CPU 103.

A hopper drive circuit 113 drives and controls a hopper 114, which is a coin payout device, under a payout command issued from the CPU 103.

A seven-segment drive circuit 122 drives and controls a during-bonus information display part 33, a credit display part 34, and a payout display part 35, which are formed by a seven-segment LED.

A lamp drive circuit 116 controls lighting of each display part (REPLAY lamp 30, WAIT lamp 31, WIN lamp 32, START lamp 36) that is formed by a lamp.

The reel-part liquid crystal display device 21, the electronic shutter, and the reel back light are driven and controlled by the sub-control circuit 201. The above-mentioned peripherals may instead be configured to be driven and controlled by the main control circuit 101.

Main input-signal generating means each of which generates an input signal required to allow the microcomputer 102 to generate a control signal to each drive circuit are the start lever 13, the 1-BET switch 8, the 2-BET switch 9, the MAX-BET switch 10, the C/P switch 12, an inserted-coin sensor 117, a reel-stopping signal circuit 118, a reel index detection circuit 115, and a payout detection circuit 119. These are connected to the CPU 103 through the I/O port 110.

The start lever 13 detects the start operation of a player. The inserted-coin sensor 117 detects coins that have passed through a selector that discriminates deformed coins from coins inserted through the coin insertion slot 11. The reel-stopping signal circuit 118 detects that each of the stop buttons 15L, 15C, and 15R has been pushed and emits a stop signal. The reel index detection circuit 115 receives a signal from a rotation reference position detection switch disposed in the stepping motor and feeds a symbol position reset signal to the CPU 103. The payout detection circuit 119 receives a signal from a coin detecting part 120 disposed in the hopper 114 and feeds a payout number signal to the CPU 103.

Next, a description will be given of how these drive circuits are controlled in a stream of successive games. First, the random-number generator 108 is generating random numbers that belong to a fixed numerical range from the time when a power switch of the pachi-slot gaming machine 1 is turned on. Effective lines that match the number of coins to be bet are displayed on the reel-part liquid crystal display device 21 when the inserted-coin sensor 117 detects that a player has inserted coins or when the player operates the 1-BET switch 8, the 2-BET switch 9, or the MAX-BET switch 10 under the condition where coins are credited. The bet operation is performed such that, as shown in the enlarged view of FIG. 1, a center line L1 functions as an active pay line (hereinafter, referred to simply as “pay line”) by a one-bet operation, a top line L2A and a bottom line L2B in addition to the center line L1 function as pay lines by a two-bet operation, and a cross-down line L3A and a cross-up line L3B in addition to the center line L1, the top line L2A, and the bottom line L2B function as pay lines by a three-bet operation.

Subsequently, random-number values are sampled by the sampling circuit 109 at a timing at which the start lever 13 detects that a player has started a game. Sampled random-number values are collated with winning probability tables stored in the ROM 104, and, if a winning coincidence occurs, a winning flag of a corresponding winning combination is set up. This lottery process by software is called “probability lottery process,” the details of which will be described later.

Driving pulses are supplied to the stepping motors 112L, 112C, and 112R through the motor driving circuit 111, and the reels 24L, 24C, and 24R start rotating. The CPU 103 monitors the driving pulses being supplied, and a “pulse counter” secured by the RAM 105 is updated. The value of the pulse counter is monitored, and, when this value becomes equal to a predetermined value, symbols are regarded as having moved by one symbol (also called “one segment”), and a “symbol counter” secured by the RAM 105 increases by one count.

For example, if twenty-one symbols are positioned on the outer circumferential surface of the reel connected to the stepping motor that makes one rotation every 400 pulses, symbols move by one segment about every 19 pulses. When the value of the pulse counter becomes equal to 19 pulses, the CPU 103 determines that symbols have moved by one segment, and the “symbol counter” increases by one count.

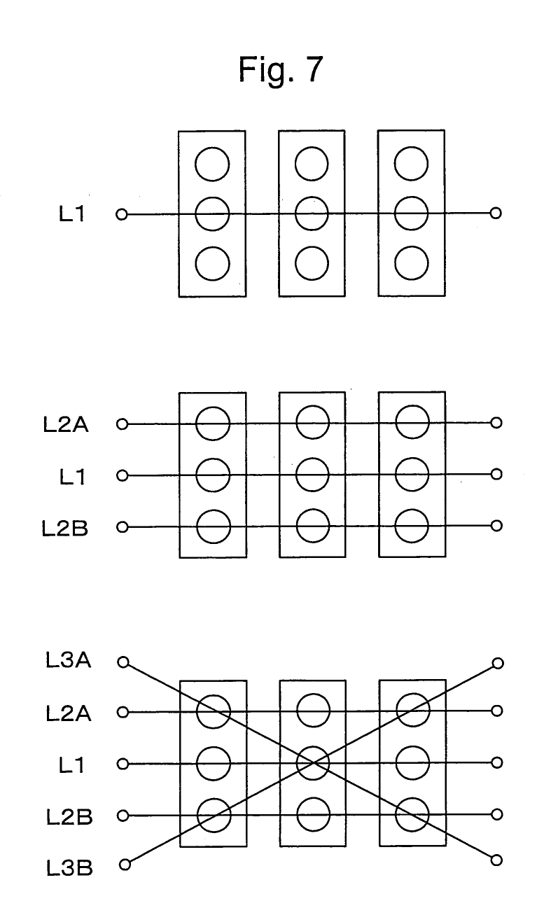

On the other hand, in the reels 24L, 24C, and 24R, an index detection signal is emitted whenever the reference symbol passes through the center line L1 of FIG. 7. A reset pulse is then input to the CPU 103 through the reel index detection circuit 115. The CPU 103 that has detected the input of the reset pulse clears the symbol counter being counted up by the RAM 105 so as to secure the coordination between a symbol position grasped through software and a symbol position displayed actually.

When the reels 24L, 24C, and 24R start rotating, and a constant-rotation state is reached after the lapse of a fixed time, the operations of the stop buttons 15L, 15C, and 15R are validated. When a player performs a stopping operation, a reel stop signal is input to the CPU 103 through the reel-stopping signal circuit 118, and software processing, such as a selection of stop positions, is performed. Thereafter, stop pulses are supplied to the stepping motors 112L, 112C, and 112R through the motor driving circuit 111, and the reels 24L, 24C, and 24R are controlled and stopped.

In order to control and stop the reels 24L, 24C, and 24R, the CPU 103 stores the code number of a symbol appearing on the center line L1 in a predetermined area of the RAM 105 as a stopping operation position when the CPU 103 receives a stop signal from the reel-stopping signal circuit 118. The CPU 103 then refers to a stopping table correlating the stopping operation position with a symbol to be stopped and displayed on the center line L1. Thereafter, the position of the symbol to be stopped that corresponds to the stopping operation position is stored in a predetermined area of RAM 105, and a calculation is performed to obtain the number of pulses (segments) to be supplied so as to stop and display the corresponding symbol. Pulses whose number has been obtained by the calculation are supplied, and stopping control is performed.

When all of the reels 24L, 24C, and 24R are stopped, winning retrieval is performed. In the winning retrieval, symbol tables stored in the ROM 104 are first collated with the symbol stop position stored in the RAM 105 so as to grasp a situation in which the stop mode of the present game is exhibited. The symbol table is formed in correspondence with a train of symbols drawn on the outer circumferential surfaces of the reels 24L, 24C, and 24R. The symbol table has a correlation between the code number representing the order of symbols from the reference position and the symbol code formed to correspond to the code number, and serves as a software reel belt. Thereafter, concerning the pay lines L1, L2A, L2B, L3A, and L3B, the stop mode is collated with winning-symbol combination tables stored in the ROM 104, and a determination is made as to whether a prize is won or not. The winning-symbol combination table represents a correlation, for example, between the combination of winning symbols and the number of coins to be paid out when a prize is won, and, according to this, a winning-symbol changing process is performed, for example, in changing a winning symbol combination that becomes effective in accordance with a game situation or changing the number of coins to be paid out.

When a determination to be “prize winning” is made by the prize winning retrieval, the CPU 103 supplies a payout signal to the hopper drive circuit 113 so as to pay out a predetermined number of coins from the hopper 114. When paid out, the coin detecting part 120 counts the number of coins paid out from the hopper 114, and, when the count value reaches a predetermined value, the transmission of a driving signal to the hopper drive circuit 113 is stopped so as to stop the coin payout.

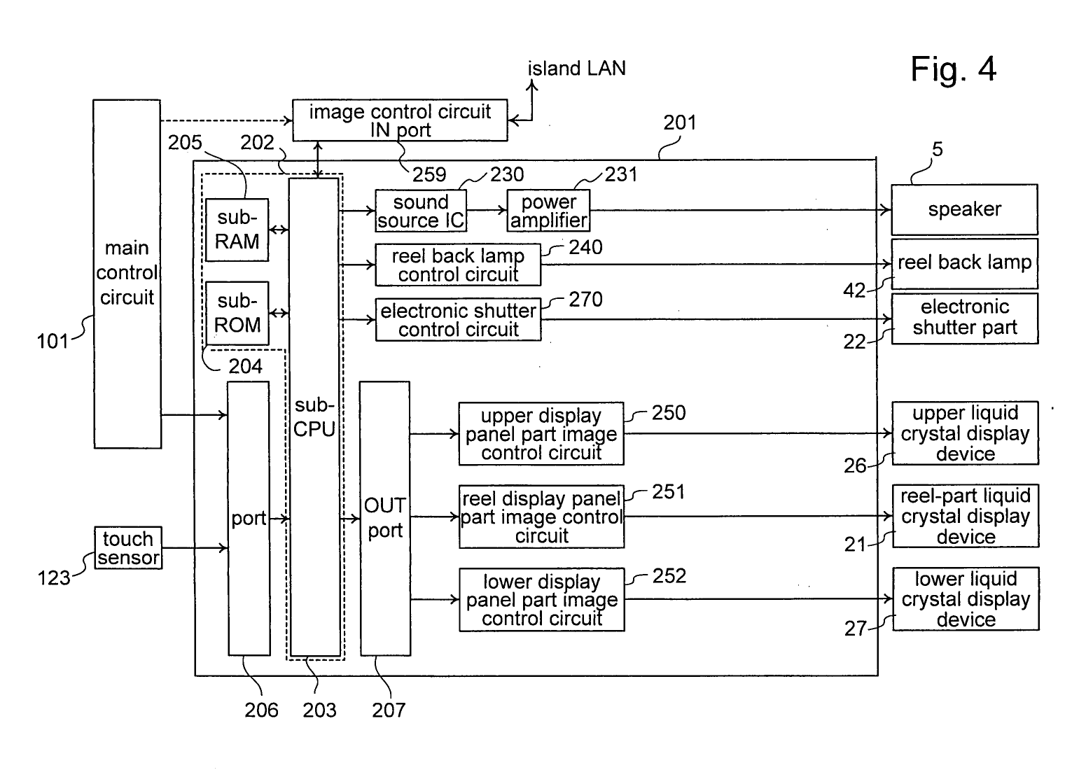

FIG. 4 is a block diagram showing the structure of the sub-control circuit 201. The sub-control circuit 201 controls effect-related peripheral devices, such as the liquid crystal display devices and the speakers 5L and 5R, based on game information transmitted from the main control circuit 101 or based on an input signal transmitted from the touch panel.

The sub-control circuit 201 includes a sub-microcomputer 202, which is a main constituent element, an upper display panel image control circuit 250 that drives and controls liquid crystal display devices, a reel display panel image control circuit 251, a lower display panel image control circuit 252, a sound source IC 230 that controls a sound emitted from the speakers 5L and 5R, a power amplifier 231 that is used as an amplifier, a reel back lamp control circuit 240, and an electronic shutter control circuit 270 that controls and shuts the reel display panel. These control circuits are constituted by a circuit board differing from that of the main control circuit 101.

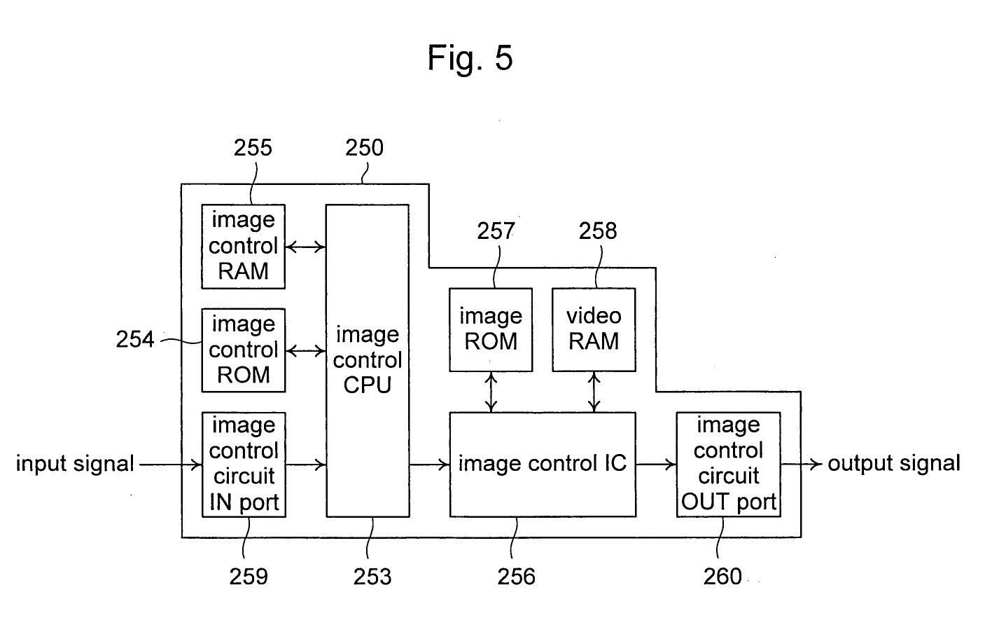

The sub-microcomputer 202 includes a sub-CPU 203, a sub-ROM 204 serving as a storage means, and a sub-RAM 205. Like the main control circuit, the sub-control circuit 201 of FIG. 5 includes a clock pulse generation circuit, a frequency divider, a random-number generator, and a sampling circuit, which are not shown. The sub-ROM 204 stores a communication sequence program with the main control circuit 101, an effect selecting table that selects various effects, etc., based on received game information, and a sound sequence program. The sub-RAM 205 is used as a work area to execute these control programs.

Based on a command transmitted from the main control circuit 101, the sub-CPU 203 determines the manners of an effect to be controlled by various effect control circuits, and the contents determined by the sub-CPU 203 are transmitted to the effect control circuits.

The reel back lamp control circuit 240 is used to control the display of an effect, such as a winning effect or the previous notice of a winning flag.

The electronic shutter control circuit 270 controls the electronic shutter 22 so that the electronic shutter 22 disposed between the reel-part liquid crystal display device 21 and the reels 24L, 24C, 24R generates a visible state or an invisible state based on whether voltage has been applied or not. Based on the contents determined by the sub-microcomputer 202, the electronic shutter control circuit 270 brings a necessary display area into an invisible state so as to shut an area inside the reel-part liquid crystal display device 21 which is specified so as not to be visually discerned by a player. For example, during a super time game that is a special game for which an appropriate stop order is notified in accordance with a selected stopping table, only the first stopping operation reel part is controlled so as to be visually discerned, and the other reel parts are brought into an invisible state when the start lever 13 is operated. As a result, the player can properly recognize which one of the reels is a reel for the first stopping operation.

The image control circuit is comprised of a plurality of control circuits that control the liquid crystal display devices provided in the respective display panels, i.e., is comprised of the upper display panel image control circuit 250, the reel display panel image control circuit 251, and the lower display panel image control circuit 252. FIG. 5 is a block diagram of an example of the image control circuits and shows the reel display panel image control circuit 251. The reel display panel image control circuit 251 controls an image displayed on the reel-part liquid crystal display device 21 and is comprised of an image control CPU 253, an image control ROM 254, an image control RAM 255, an image ROM 257, a video RAM 258, and an image control IC 256. The image control CPU 253 receives parameters determined by the sub-microcomputer 202 through an image control circuit IN port 259 and determines the contents to be displayed on the reel-part liquid crystal display device 21 in accordance with an image control sequence program stored in the image control ROM 254. The image control ROM 254 stores a reception sequence program of an image effect command transmitted from the sub-microcomputer 202, an image control sequence program that controls the image control IC 256, etc. The image control RAM 255 is used as a work area when the image control program is executed.

The CPU 103, the sub-CPU 203, and the image control CPU 253 are functionally united together and constitute a controller that controls the reels, the image display devices, and the payout device while executing a predetermined program.

The image control IC 256 forms an image according to the display contents determined by the image control CPU 253 by use of graphic data stored in the image ROM 257. The image is temporarily stored in the video RAM 258 and is outputted to the reel-part liquid crystal display device 21 through an image control circuit OUT port 260 at a proper timing, thus creating a display effect.

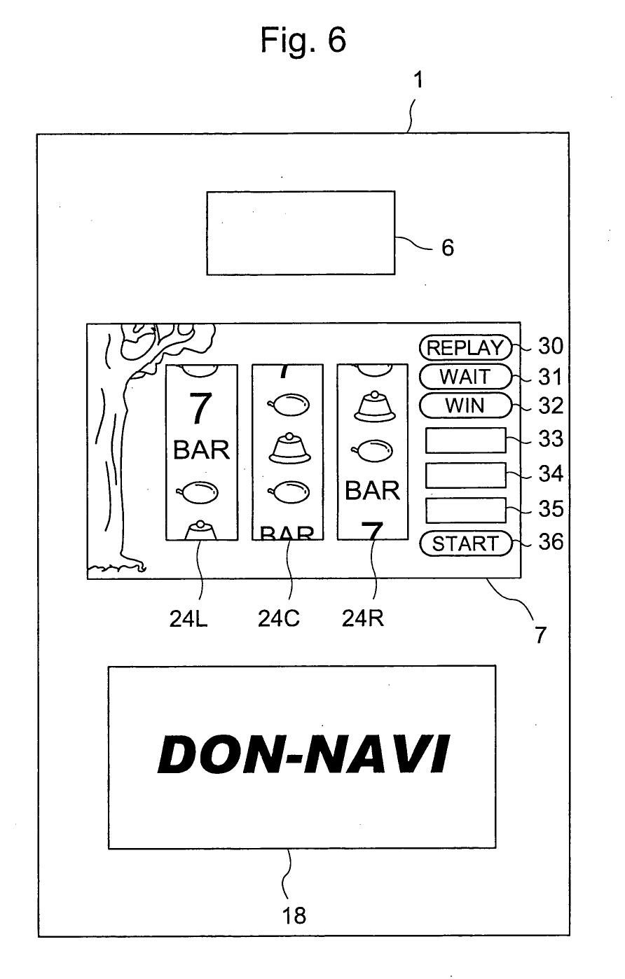

FIG. 6 is a front view of the pachi-slot gaming machine 1, especially showing the upper display panel 6, the reel display panel 7, and the lower display panel 18. In this embodiment, a liquid crystal display device that is an electric display device is provided as an image display device in each display part, on which various images are displayed depending on a game situation. The reel display panel 7 is in a state in which symbols on the reels 24L, 24C, and 24R can be visually discerned through the reel-part liquid crystal display device 21 and the electronic shutter 22. Reel symbols can be visually discerned from the side of a player in this way when the reel-part liquid crystal display device 21 and the electronic shutter 22 are under transparent control (i.e., visible control), but, when an image is displayed on the reel-part liquid crystal display device 21 or when the electronic shutter 22 is subjected to opaque control (i.e., invisible control), the reel symbols cannot be visually discerned.

The lower display panel 18 includes the lower liquid crystal display device 27, on which a model name and symbols that match the concept of the gaming machine are chiefly displayed. In the figure, the model name “DON-NAVI” is displayed. These images are subjected to image control based on image data stored in the image ROM of the lower display panel image control circuit 252 of the sub-control circuit 201. Therefore, the need to produce a lower display panel for each model or the need to attach a new lower display panel in a manufacturing step does not arise by exchanging the sub-control circuit 201 or the lower display panel image control circuit 252 with another one whenever the model is changed. Therefore, various models can be easily manufactured.

The upper display panel 6 used as a payout display means includes the upper liquid crystal display device 26, on which a payout table is chiefly displayed. In this embodiment, the upper display panel 6 is structured so that the amount of media (e.g., number of coins) to be paid out can be changed by a fixed input operation, and the display contents of the payout table can also be changed in accordance with parameters. The details of this will be described later.

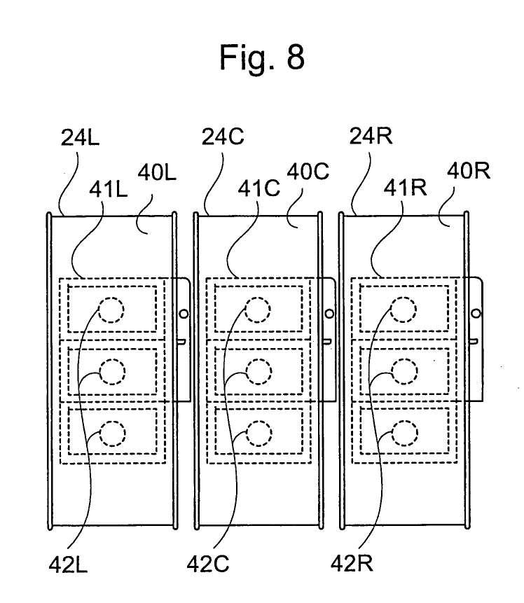

FIG. 8 is an enlarged view of the reels 24L, 24C, and 24R. The reel belts 40L, 40C, and 40R of the reels 24L, 24C, and 24R are made of semitransparent films. Symbols, such as “cherry” symbols and “7” symbols, are printed thereon with light-permeable colored ink. The remaining area other than the symbols are masked with opaque ink. Lamp casings 41L, 41C, and 41R are provided behind the reel belts 40L, 40C, and 40R so that light emitted from each lamp does not interfere with the area of the symbols. Reel back lamps 42L, 42C, and 42R are contained in the rooms of the lamp casings 41L, 41C, and 41R, respectively. Based on parameters determined by the sub-microcomputer 202, the reel back lamp control circuit 240 controls and blinks the reel back lamps 42L, 42C, and 42R. For example, the reel back lamps 42L, 42C, and 42R for symbols positioned on a pay line are blinked when coins are paid out, or different blinking modes are prepared for each internal-winning combination, and effect displaying is performed when each winning flag is established. Thus, it is possible to recommend which one of the winning symbols a player should target.

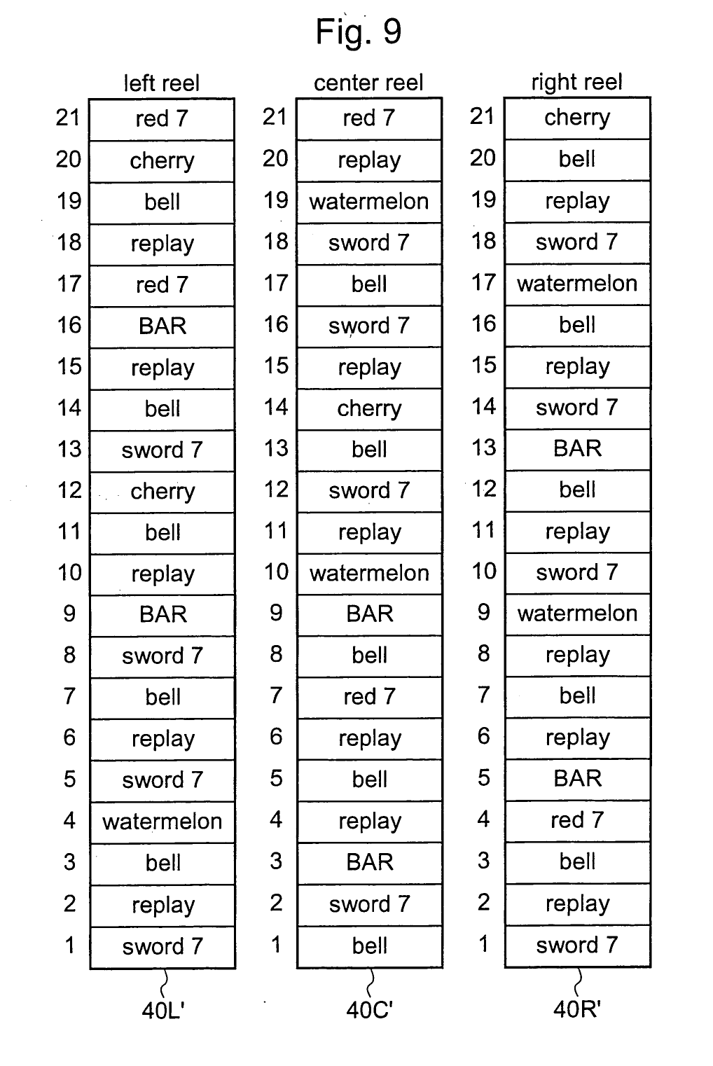

FIG. 9 is a view planarly expanding the reel belts 40L, 40C, and 40R. Each reel has twenty-one symbols. Each symbol has numbers 1 to 21 and is stored in the ROM 104 in the form of a symbol table. Symbol trains 40L′, 40C′, and 40R′ are moved in order of the symbol number (up from below) in response to the rotation of the reels 24L, 24C, and 24R.

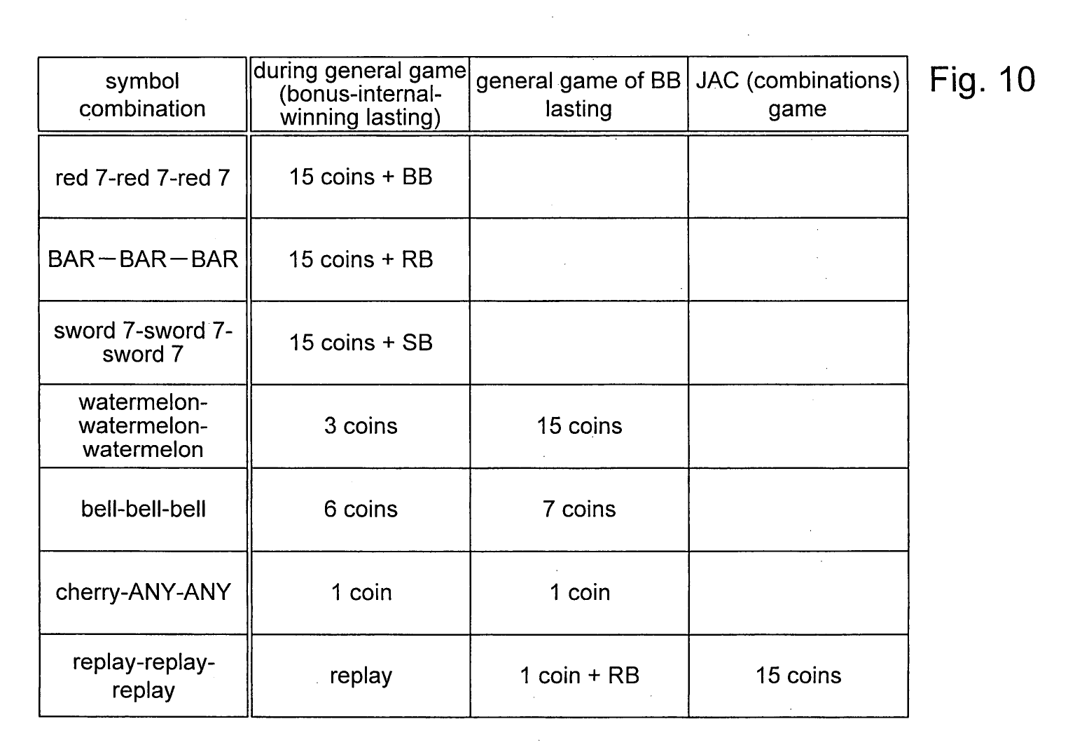

FIG. 10 is a view showing a payout table that shows the number of media (e.g., coins) to be paid out with respect to a winning symbol combination (i.e., winning combination) in each game situation.

A description will be given of “internal winning,” “winning,” and “game situation.” “Internal winning” is a state in which sampled random-number values are collated with winning probability tables in the aforementioned probability lottery process, and, as a result, a determination to be “winning” is made, and a winning flag of a corresponding winning combination is set up.

The winning flag exists, in principle, for each winning combination and is divided chiefly into two in accordance with its characteristic. One is a winning flag for a winning combination, called a “small” winning combination, that is relatively small in the number of media to be paid out, that is effective for an effected game, and that is not carried forward to the next game. The other one is a winning flag for a winning combination, called a “bonus” winning combination, that is great in the number of media to be paid out and that is carried forward until prize winning is obtained without being used only for an effected game so that the internal lottery probability of a winning combination called a big bonus (BB) or a regular bonus (RB) can increase.

As examples of the small winning combination, there are a “cherry” winning combination that wins a prize merely when a symbol stops on an pay line of the left reel, a “bell” winning combination that wins a prize when three symbols are stopped and aligned on an pay line, and a “watermelon” winning combination. As examples of the bonus winning combination, there are a regular bonus and a big bonus. The regular bonus (RB) is generated, for example, when symbols of “BAR-BAR-BAR” are aligned on an activated pay line. Fifteen coins are first paid out when the prize is won. After that, a one-coin-bet bonus game (called “JAC game” or “winning-combination game”) can be played twelve times or until eight prizes are won. The big bonus (BB) is generated, for example, when symbols of “red7-red7-red7” are aligned on an pay line. Fifteen coins are first paid out when the prize is won. After that, during the BB game, a game in which the winning probability of a small winning combination called “general game” or of the RB has increased can be played up to the limit of thirty times. The RB game can be played up to three times during the BB game. RB-prize winning from a general game is generated, for example, when symbols of “BAR-BAR-BAR” are aligned, but RB-prize winning from a general game during the BB game is generated when symbols of “replay-replay-replay” are aligned. In the replay winning combination, the same number of coins as the loaded coins are inserted automatically when won, and therefore the next game can be played without inserting coins. The single bonus (SB) is generated, for example, when symbols of “7 with sword-7 with sword-7 with sword” are aligned on an pay line. Fifteen coins are first paid out when the prize is won, and then a JAC game can be played once. Although the SB has the name “bonus,” a winning flag is not carried forward. Like the small winning combination, the winning flag is effective only for the present game.

Next, a game situation will be described. The game situation is divided chiefly into three situations, based on whether the winning flag of the bonus winning combination exists or not. That is, there are a general game situation in which a bonus winning combination has not yet obtained internal winning, a bonus internal winning situation (also called “bonus internal winning”) in which bonus winning symbols have not yet been aligned on an pay line, and prize winning has not been generated although internal winning is obtained in a probability lottery process, and a bonus game situation (also called “enabled bonus”) in which winning symbols are well aligned on an pay line during bonus internal winning, and a bonus game is being played.

Further, the bonus internal winning is divided into BB internal winning and RB internal winning, based on a bonus kind. The “enabled bonus” is also divided into enabled BB and enabled RB.

Besides the bonus winning combination, there is a game situation advantageous to a player who can obtain a large number of coins.

For example, a specific state is known concerning a winning probability table of SB during a general game which is called “concentrated machine.” A high probability table (e.g., SB internal-winning probability 1/2) and a low probability table (e.g., SB internal-winning probability 1/20) are prepared. When the low probability table is used, a lottery (generally, called “plunge lottery”) switched to the high probability table is operated, and, on the contrary, when the high probability table is used, a lottery (generally, called “blowout lottery”) switched to the low probability table is operated. Thus, the number of coins gradually increases when the high probability table is used.

In addition, a specific function called the “AT (assist time) function” is known. In this function, multiple prize patterns that can never be won at the same time are set. For example, the winning combinations, “bell-bell-red 7,” “bell-bell-blue 7,” and “bell-bell-white 7,” are provided with intervals of four segments or more each being set among the symbols, “red 7,” “blue 7,” and “white 7” on the right reel. Since the kind of internal-winning combination is not notified in an ordinary state, a player does not know which one of the “7”s is to be targeted, and, theoretically, the probability with which a prize is won is only 1/3 after internal winning. However, when a state called an AT period in which the kind of internal winning is notified is reached, the targeted kind of a “7” symbol is understood. Therefore, theoretically, a prize will be won with a probability of 100% after internal winning merely by accurately performing an observation push. In this specific state, the number of coins gradually increases.

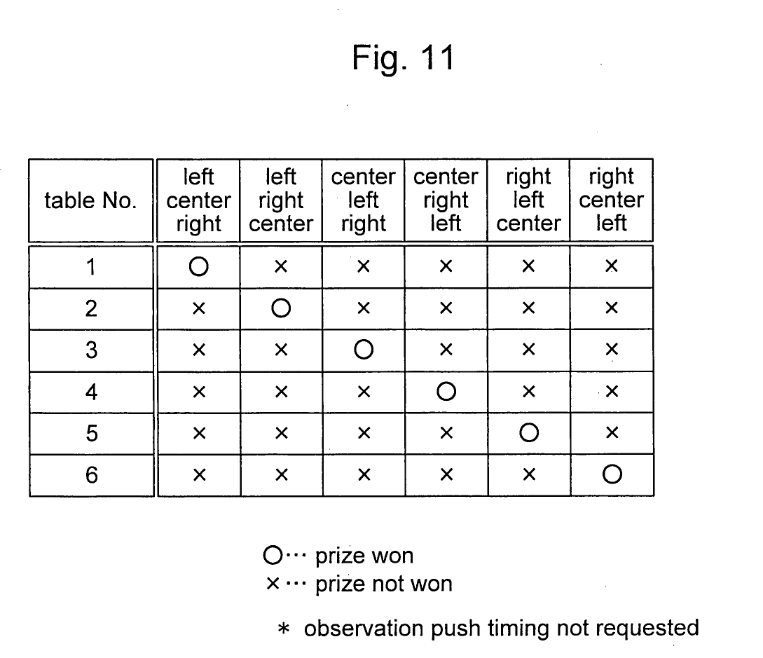

There is also a specific function called “super time function,”. Under this function, if predetermined stopping control is not performed for one internal-winning combination, winning symbols are not aligned even if a internal winning is obtained and even if an accurate observation push is operated. For example, as shown in FIG. 11, six kinds of stop-order tables are prepared from “NO. 1” to “NO. 6” concerning the winning combination “bell,” and a stopping table to be used is selected, for example, by a random-number lottery when internal winning of the “bell” is obtained in a probability lottery process. For example, when the stopping table of table “NO. 3” is selected in the present game, the center stop button 15C is pushed by the first stopping operation, the left stop button 15L is pushed by the second stopping operation, and the right stop button 15R is pushed by the third stopping operation, thereby winning combination is realized. According to the remaining five kinds of stop orders, stopping control is performed under which bell symbols are not aligned on the pay line even if internal winning of the “bell” is obtained.

Since this stop order is not notified in an ordinary state, the probability with which a prize is won is theoretically only 1/6 after internal winning. However, when a state called “super time period” in which the kind of selected stopping table is notified, in other words, in which the order to be stopped is notified is reached, a prize can be won theoretically with a probability of 100%, and the number of coins gradually increases. In this embodiment, the number of media (coins) to be paid out is changed according to a game situation even if winning symbols are the same. For example, a “watermelon” winning combination is provided with three paid out coins during a general game and during bonus internal winning, but is provided with fifteen paid out coins in a general game during BB. “Replay-replay-replay” is a combination of replay winning symbols during a general game and during bonus internal winning, but is a combination of RB winning symbols in a general game during BB and is a combination of winning symbols in a JAC game, according to which fifteen coins are paid out.

Further, in this embodiment, besides the bonus winning combination, the aforementioned super time is employed as a situation advantageous to a player. When a predetermined condition is satisfied during a general game, a super time game can be played. In greater detail, when internal winning is placed on the SB winning combination or the bell winning combination, a player is notified of information about a stop order required to match-up the combinations of symbols to win a prize. Therefore, prize winning can be reliably generated without an missed winning by allowing the player to operate in accordance with the notified stop order when the SB winning combination or the bell winning combination obtains internal winning. In this embodiment, it is possible to change the number of media to be paid out with respect to the same winning combination based on the payout table of FIG. 10 by performing a certain input operation.

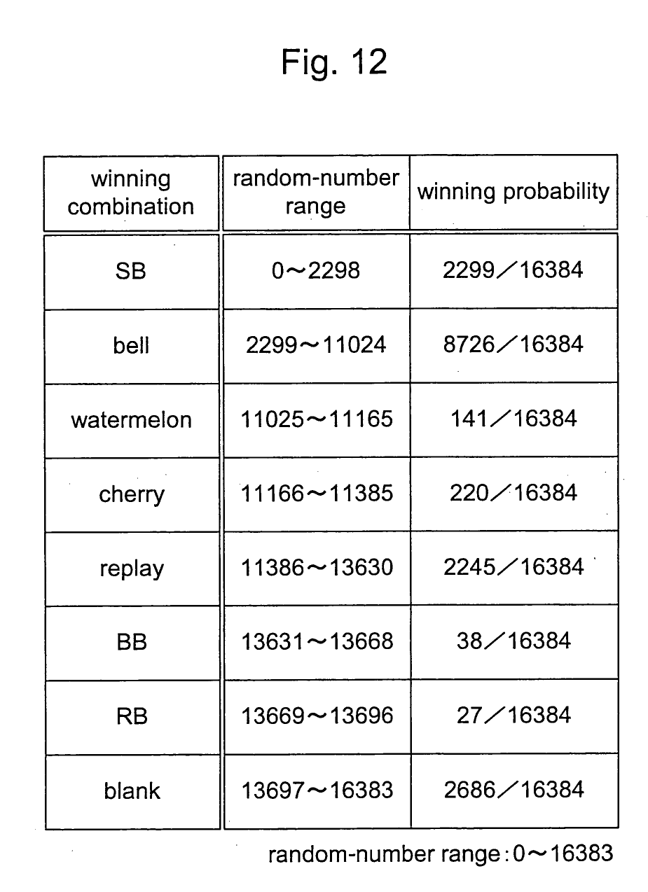

FIG. 12 is a view showing a winning probability table used for the aforementioned probability lottery process. A random-number value is extracted within a range of “0 to 16383,” and, when it belongs to a winning range determined for each winning combination, a corresponding winning combination is won internally. For example, when a random-number value extracted in the present game is “10000,” it belongs to a winning range of “2299” to “11024” for a bell winning combination, and a bell winning combination is won internally. When a random-number value extracted in the present game is “15000,” it belongs to a loss range (i.e., lottery-losing range) of “13669 to 16383,” and each winning combination cannot obtain internal winning and results in a loss.

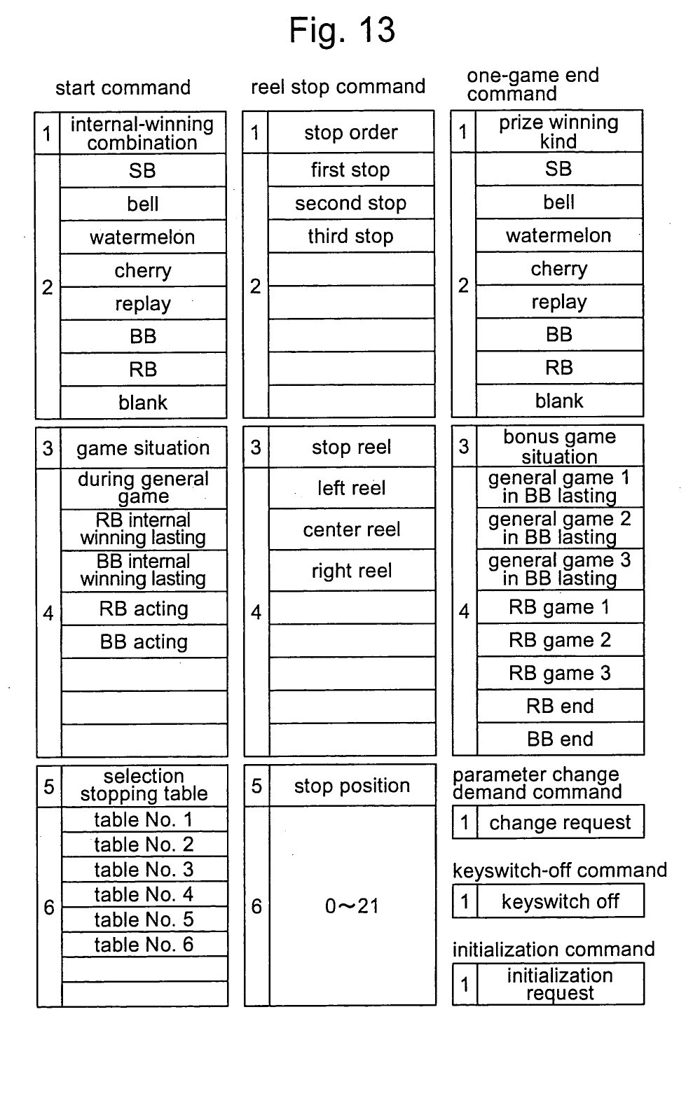

FIG. 13 is a view showing a game information command table from the main control circuit 101. In this embodiment, a substrate of the main control circuit 101 that controls a winning determination, coin payout, etc., is different from a substrate of the sub-control circuit 201 that controls the reel-part liquid crystal display device 21, the speakers 5L, 5R, etc. Since game information concerning a state of internal winning or a stopped state of a reel processed by the main control circuit is required for effect control processed by the sub-control circuit 201, both of the substrates are connected together through a straight cable, through which necessary information is transmitted. As the command to be transmitted, there are a “start command” transmitted when a player operates the start lever 13, a “reel stop command” transmitted when the stop buttons 15L, 15C, and 15R are pushed to stop the rotation of the reels 24L, 24C, and 24R, a “one-game end command” transmitted when one game is completely ended, a “parameter change demand command” to allow the machine to execute a parameter changing process, by which the number of media to be paid out and the internal-winning probability can be changed when the power source of the pachi-slot gaming machine 1 is started up, a “keyswitch off command” transmitted when a keyswitch is turned off, and an “initialization command” to allow each liquid crystal display device to display an initial image.

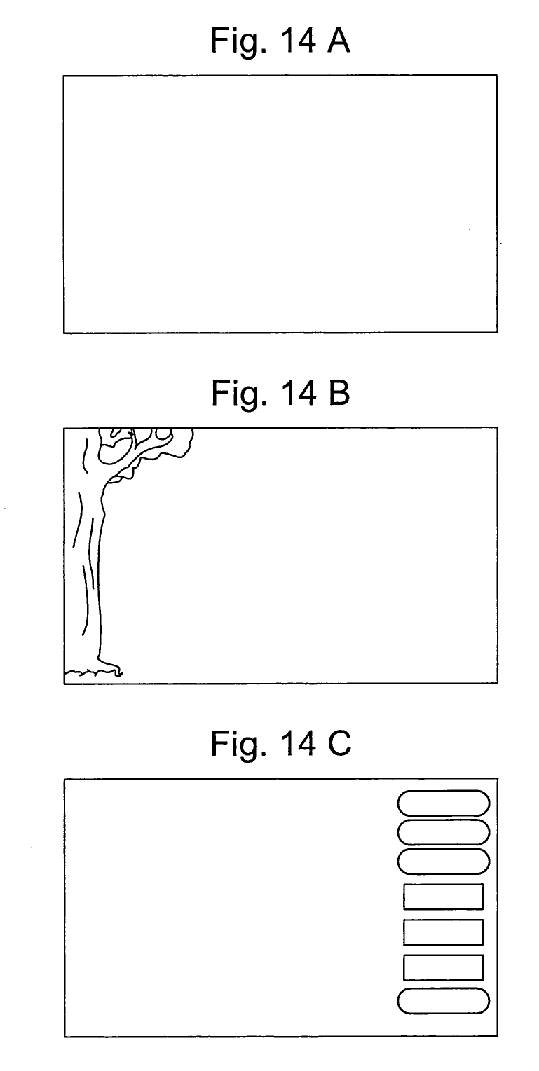

FIG. 14A to FIG. 14C are a view showing various members that constitute the reel display panel 7. FIG. 14A is a front view of the reel display panel 7. The reel display panel 7 that is a transparent acrylic plate to which the touch panel 28 is stuck can withstand a physical shock from the outside. FIG. 14B is a front view of the picture sheet 20. In this embodiment, the picture sheet 20 formed by printing pictures with semitransparent ink on a transparent film has a picture of a tree at the left thereof. FIG. 14C is a front view of the electronic shutter 22. The electronic shutter 22 is made of a liquid crystal film and performs switching between a transparent state and an opaque state depending on voltage to be applied. The display area of each lamp part and the seven-segment display part at the right of the electronic shutter is kept transparent, regardless of whether voltage has been applied or not, so as to be always visually discerned by a player.

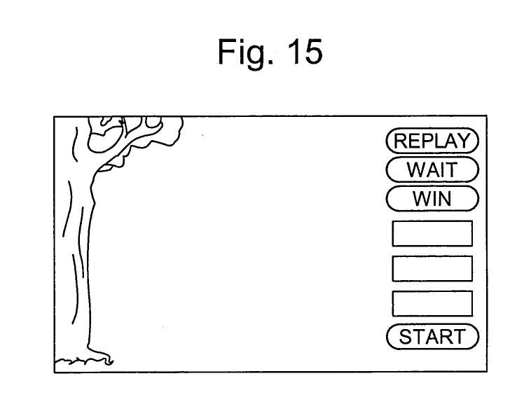

FIG. 15 is an enlarged view of the reel display panel 7 when the electronic shutter 22 is in an opaque state (i.e., voltage-not-applied state) concerning the overall area. For example, this is a display state reached when the power source of the pachi-slot gaming machine 1 is off. In this state, the reel 24 is hidden by the electronic shutter 22 so as not to be visually discerned by the player. However, since the picture sheet is disposed in front of the electronic shutter 22 (i.e., on the side of the player), the picture sheet can be visually discerned by the player without being affected by the control state of the electronic shutter 22. Each lamp display part and the seven-segment display part at the right of the reel display panel are disposed inner side of the electronic shutter 22. However, since a corresponding display area of the electronic shutter 22 is always in a transparent state, each lamp display part and the seven-segment display part can be visually discerned by the player.

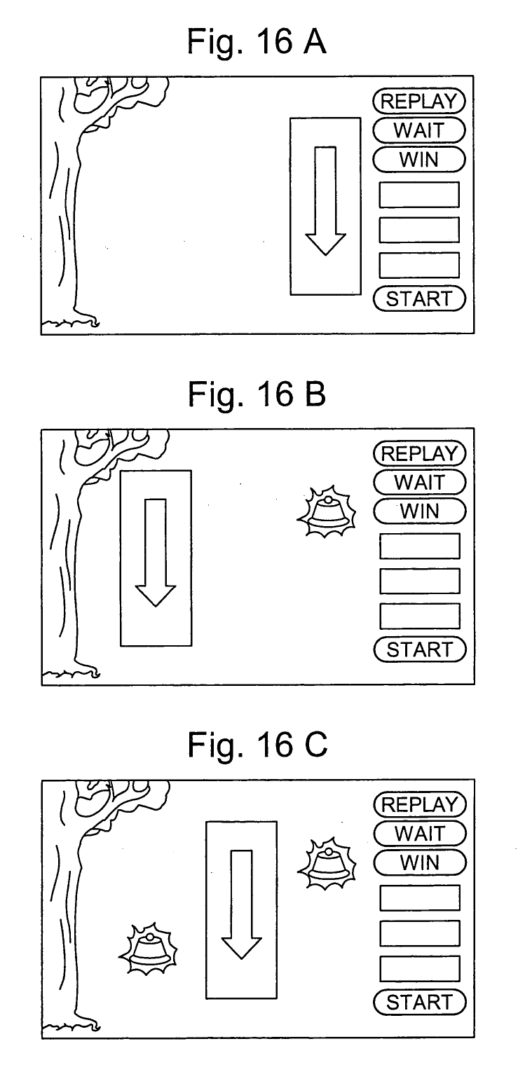

FIG. 16A to FIG. 16C are views showing an effect screen during a super time game that is in a special game situation. As an example of an effect control operation during a super time game, FIG. 16A shows the reel display panel 7 prior to a first stopping operation when internal winning of the “bell” is obtained, and table No.5 of the stopping table of FIG. 11 is selected. In this embodiment, an appropriate stopping operation is recommended by operating the electronic shutter 22 so as to exert transparent control only on a display area of a reel corresponding to a stop button to be stopped and by operating the electronic shutter 22 so as to exert opaque control on the remaining area. Since the stopping table No.5 corresponds to the right stop button of the first stopping operation, the display area excluding the right reel 24R reaches an opaque state, and only the right reel 24R being rotating can be visually discerned by a player. Accordingly, a recommendation is made that the player should stop the right stop button 15R. Herein, the term “transparent control” means that the electronic shutter 22 is controlled so that reel symbols positioned behind can reach a discernible state. Therefore, if it falls within a range where reel symbols can be visually discerned by the player, it is permissible to be in a colored state or in a semitransparent state, not in a completely transparent state. Likewise, concerning the opaque state, it is permissible to be in a somewhat semitransparent state if reel symbols positioned behind cannot be visually discerned in greater or lesser degree, without being limited to a state of being optically completely impermeable.

FIG. 16B is a view showing the reel display panel 7 when the player pushes the right stop button 15R in the state of FIG. 16A. Since the right-stop-button as first-stop-button is a proper stopping operation, the player is notified of the fact that the operation was a proper stopping operation. Notification is realized by allowing only the bell symbols that are an internal-winning combination of symbols to become visually discernible and by allowing the remaining area to become visually indiscernible concerning the display area in which rotating right reel 24R has been visually discerned in FIG. 16A. The display area of the left reel 24L being in an opaque state in FIG. 16A reaches a transparent state, and the rotating left reel 24L can be visually discerned. Accordingly, it is recommended that the player should operate the left reel 24L next.

FIG. 16C is a view showing the reel display panel 7 when the player pushes the left stop button 24L in the state of FIG. 16B. Since the left-stop-button-second stop is a proper stopping operation, the player is notified of the fact that the operation was a proper stopping operation. Notification is realized by allowing only the bell symbols that are an internal-winning combination of symbols to become visually discernible and by allowing the remaining display area to become visually indiscernible concerning the display area of the rotating left reel 24L has been visually discerned in FIG. 16B. The display area of the center reel 24C being in an opaque state in FIG. 16B reaches a transparent state, and the rotating center reel 24C can be visually discerned. Accordingly, it is recommended that the player should operate the remaining center reel 24C next.

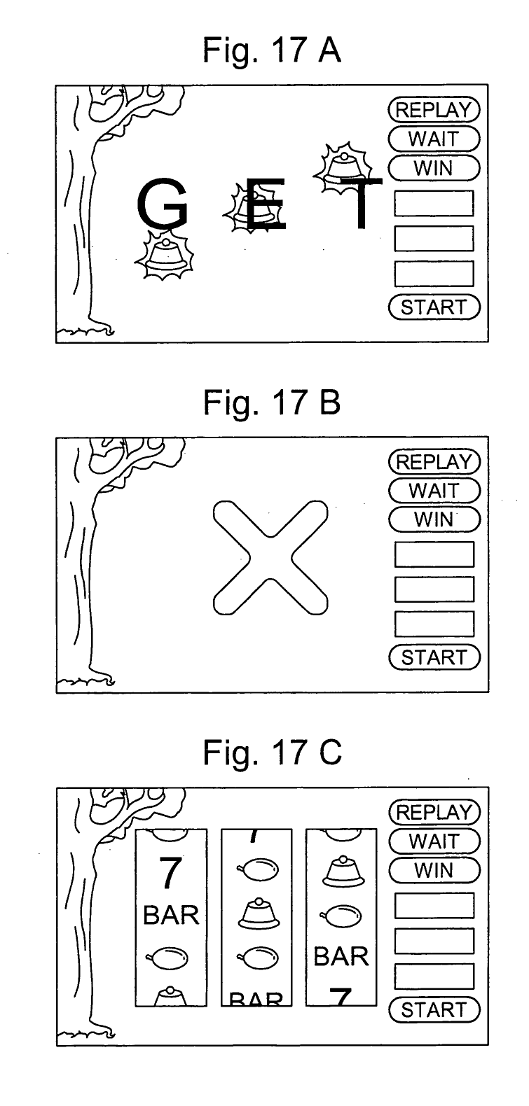

FIG. 17A is a view showing the reel display panel 7 when a winning combination is realized by properly performing all of the stopping operations during a super time game. In FIG. 17A, the electronic shutter part exerts transparent control only on the part of bell symbols that are a winning combination of symbols so that bell symbols on the reel 24 can be visually discerned, and the player is notified of the fact that the “bell” wining combination has won, by displaying the letters “GET” on the reel-part liquid crystal display device 21.

FIG. 17B is a view showing the reel display panel 7 when a stopping operation during a super time game is improperly performed, so that an missed winning occurs. For example, when the center stop button 15C is operated by mistake although the left stop button 15L really should be pushed in the state of FIG. 16B. The character “x” is largely displayed at the center of the display part, whereby the player is notified of the fact that the operation was an improper operation.

The effect control executed in FIG. 17A, or FIG. 17B is displayed during a certain time, and transparent control is then exerted on all of the opaque areas as shown in FIG. 17C, and the effect control during one game is completed.

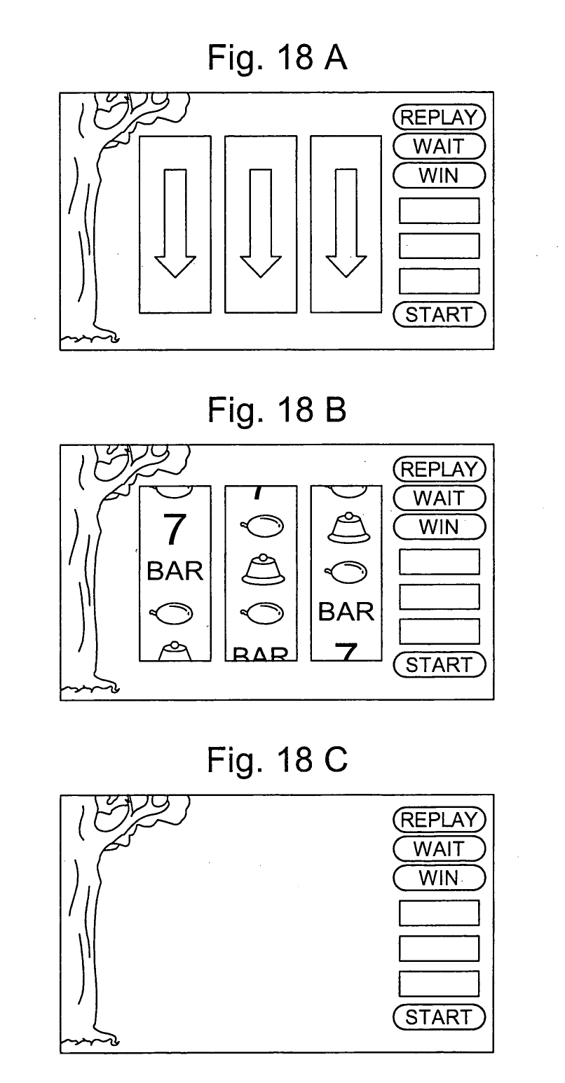

FIG. 18A to FIG. 18C are views showing a prediction effect screen generated with a predetermined probability after all of the reels 24L, 24C, and 24R are stopped. The reels 24L, 24C, and 24R rotating are first displayed through the display panel 7 (FIG. 18A), and then all of the reels are stopped after a stopping operation by player (FIG. 18B)). After all of the reels are stopped, the electronic shutter 22 reaches an opaque state, and the reels 24L, 24C, and 24R are hidden behind the electronic shutter as shown in FIG. 18C.

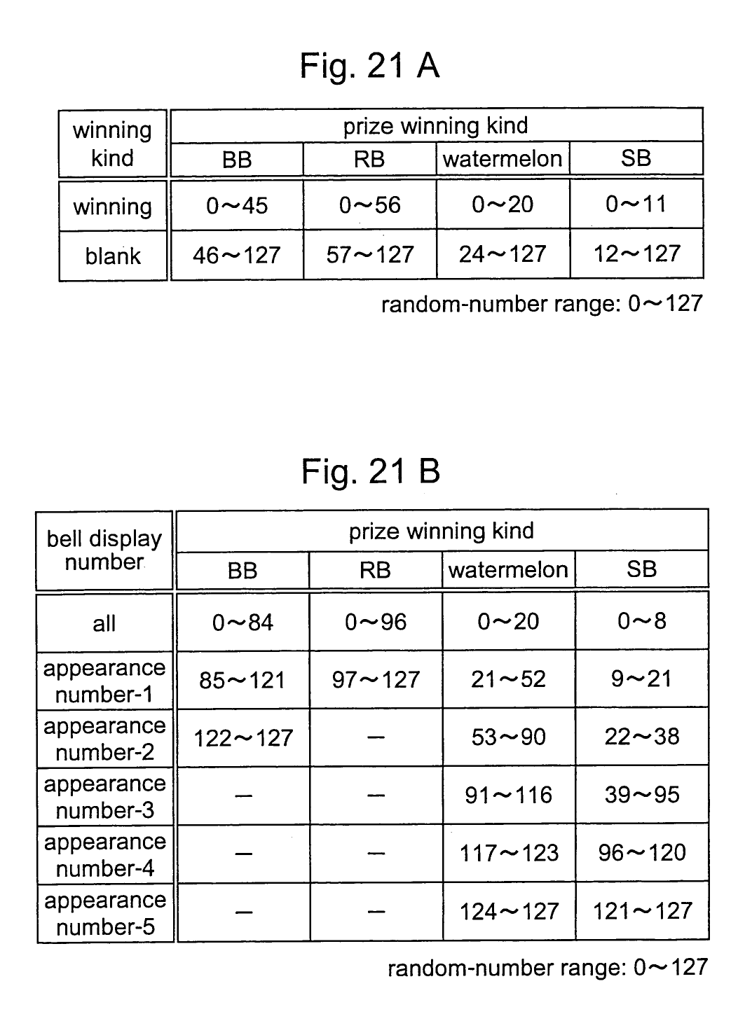

Thereafter, a prediction effect based on a internal-winning combination in the present game is executed. The prediction effect of this embodiment has contents that exhibit the reliability of the generation of a bonus winning combination, depending on the degree of coincidence between the display positions of bell symbols displayed on the reel-part liquid crystal display device 21 and the stopped positions of bell symbols of the reels 24L, 24C, and 24R that have been stopped and displayed. FIG. 21A is a view showing a prediction effect generation table. If BB, RB, “watermelon,” and SB obtain internal winning in a probability lottery process, reference is made to the prediction effect generation table when a lottery is operated as to whether a prediction effect is to be executed or not. For example, when internal winning of “watermelon” obtained, and an effect-selecting random-number value is 15, an effect occurs, but, when the internal-winning combination is SB, an effect does not occur even if the effect-selecting random-number value is 15.

FIG. 21B is a view showing an effect-kind selection table. If the generation of the prediction effect is determined by the prediction effect generation table, reference is made to the effect-kind selection table to determine the contents of the effect. The effect is divided based on the accuracy with which a coincidence is created between the stopped positions of bell symbols of the reels 24L, 24C, and 24R and the stopped positions of bell symbols of the reel-part liquid crystal display device 21. The probability that a bonus winning combination will be won internally is high proportionately with the greatness of degree of the coincidence. For example, “All” in the column of “Bell display number” in the figure denotes that all display positions of both-side symbols coincide with each other, and “Appearance number-2” denotes that two display positions, the number of which is the maximum, of the both-side symbols are not displayed with each other. For example, if the internal-winning combination is “SB” in the present game, and the effect-selecting random-number value is 118, the effect of “Appearance number-4” is selected. For example, when only two bell symbols are stopped and displayed on the reels 24L, 24C, and 24R, an effect manner is selected according to which all display positions do not coincide with each other. For example, when five bell symbols are stopped and displayed thereon, four display positions are displayed in the state of non-coincidence, and one display position is displayed in the state of coincidence.

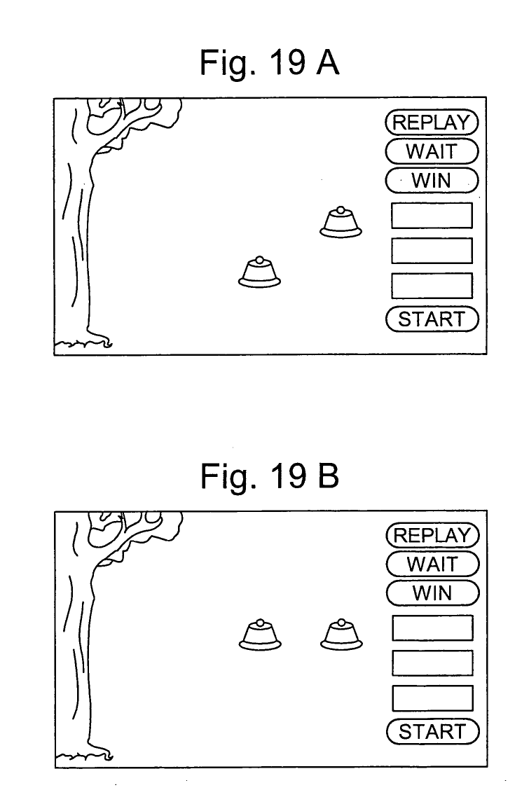

FIG. 19A and FIG. 19B are views showing a concrete example of the prediction effect mode. FIG. 19A is a view that is displayed when one is selected among “Appearance number-2,” “Appearance number-3,” “Appearance number-4” and “Appearance number-5” of the effect-kind selection table of FIG. 21B when the reels 24L, 24C, and 24R are stopped in the display mode of FIG. 18B. In the reel stop mode of FIG. 18B, on the reels, bell symbols are displayed on the middle part of the center reel 24C and the upper part of the right reel 24R, but, on the reel-part liquid crystal display device 21, bell symbols are displayed on the lower part of the center reel and the middle part of the right reel. From this, it is understood that the prediction effect is low in reliability so that the display positions of the both-side symbols do not coincide with each other.

FIG. 19B is a view that is displayed when the reels 24L, 24C, and 24R are stopped in the display mode of FIG. 18B and when one of the kinds of “Appearance number-1” is selected in the effect-kind selection table of FIG. 21B. On the reels, bell symbols are displayed on the middle part of the center reel 24C and the upper part of the right reel 24R, whereas, on the reel-part liquid crystal display device 21, bell symbols are displayed on the middle part of the center reel and the middle part of the right reel. Concerning the display position, the right reel 24R is in the state of non-coincidence, but the center reel 24C is in the state of coincidence. From this, it is understood that the prediction effect is high in reliability.

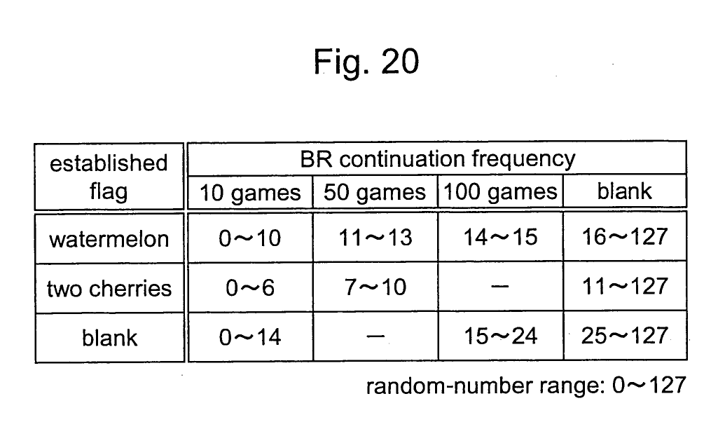

FIG. 20 is a view showing a BR generation and BR continuation number lottery table. In this embodiment, generation of a BR and a BR continuation number are settled by performing a lottery with a fixed probability when a predetermined winning combination is internally won. In the table, BR is generated with a probability of 16/128 at the “watermelon” internal winning, with a probability of 11/128 at the two-cherry internal winning, and with a probability of 25/128 at the loss.

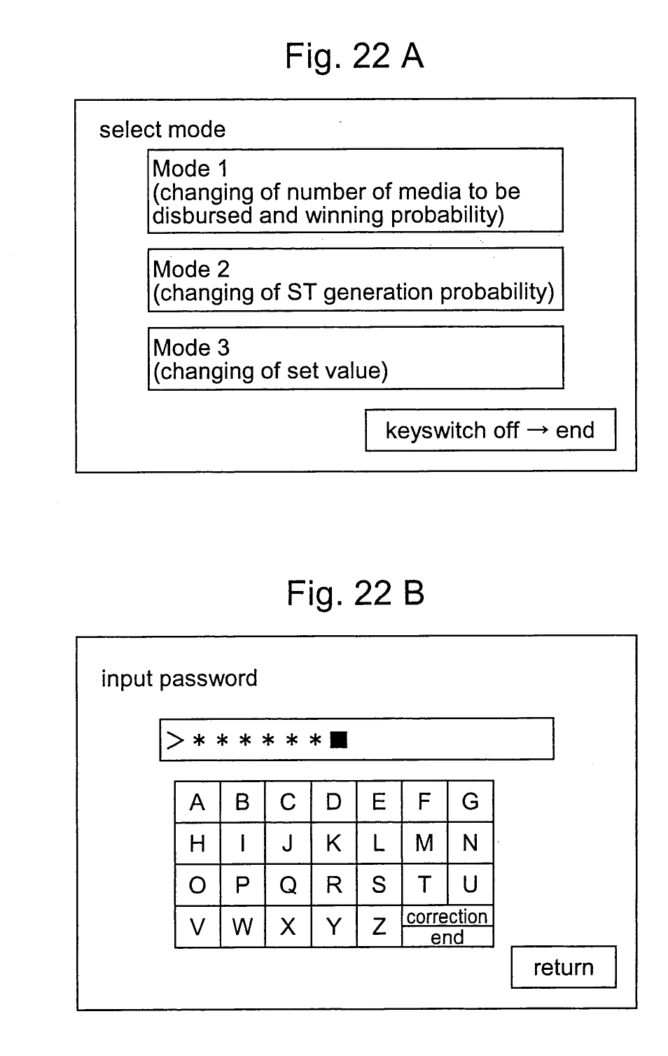

FIG. 22A is a views showing a support menu used to allow a hole clerk as a game manager to change or select the payout rate as an amount of payout of the pachi-slot gaming machine 1. A support menu screen is displayed when the electric power source of the pachi-slot gaming machine 1 is applied in a state in which a keyswitch (not shown) provided in the power supply unit disposed in the pachi-slot gaming machine is on. The support menu is comprised of three modes. Mode 1 is a mode used to change the number of coins to be paid out and the internal-winning probability for each winning combination, in which an arbitrary performance is selected from a payout-rate setting screen described later. Mode 2 is a mode used to change the number of coins to be paid out and the generation probability of a super time game for each winning combination. Mode 3 is a mode used to perform six-grade setting. One of the modes can be selected by touching each display area. When the setting is finished, “End” is selected to return to an ordinary game situation.

FIG. 22B is a view showing a password input screen displayed when Mode 1 is selected. As mentioned above, Mode 1 is a mode used to change the payout rate by changing the internal-winning probability of a winning combination of the pachi-slot gaming machine 1 and the number of media to be paid out. However, since a change in the payout rate directly affects the business contents of a game arcade, the need to improve security arises. Therefore, a password is required to be inputted when changed to a setting screen. For, example, a specified password is inputted through an character input means formed by the touch panel 28 displayed on the lower center part of the screen. After the password is inputted, an “End” command of the character input means is inputted, and the password is collated. If the password is correctly inputted, the screen is changed to the setting screen. In order to end the input operation, “Return” is selected to return to a support menu screen.

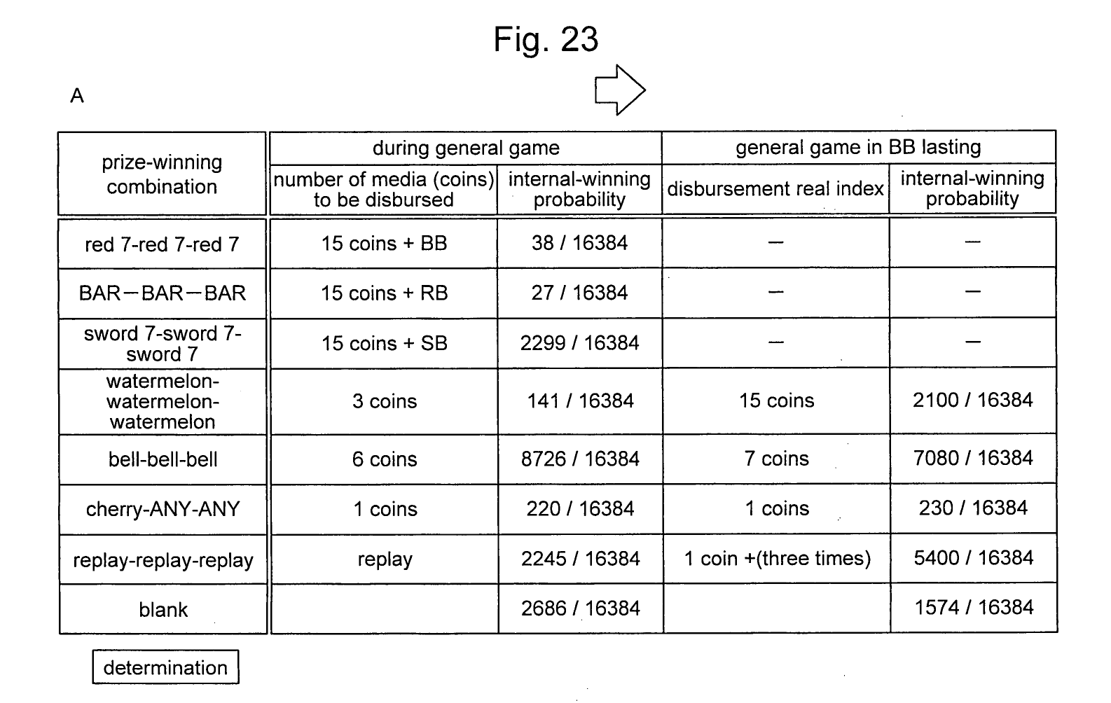

FIG. 23 to FIG. 25 are each a view showing a payout-rate setting screen. In this embodiment, a plurality of payout-rate setting screens are prepared, and the number of coins as the amount of media to be paid out and the internal-winning probability are determined depending on each winning combination. FIG. 23 is a view showing a payout-rate setting screen A displayed after a password is inputted on a password input screen. The setting screen A can set a standard payout rate. The internal-winning probability and the number of media to be paid out during a general game and in a general game during BB are set in accordance with the winning symbol combination of each winning combination listed at the left of the screen. For example, in “watermelon” in a general game situation, the internal-winning probability is 141/16384, and the number of media to be paid out when the winning combination is realized is three. A screen-changing icon is displayed at the upper center of the screen. The present display screen can be changed to a next screen by touching the icon. If a screen is to be intentionally used, a determination is made by touching a “Determine” icon at the lower left of the screen, thus returning to a support menu screen of FIG. 22(a).

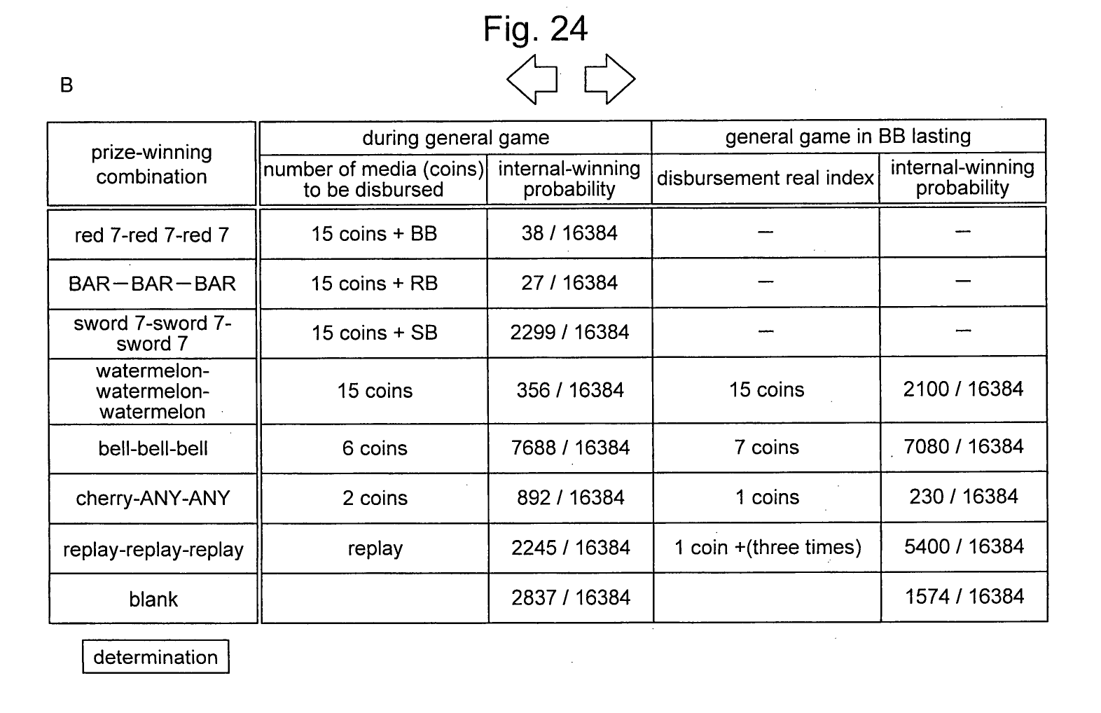

FIG. 24 is a view showing a payout-rate setting screen B. In the setting screen B, the number of coins as the amount of media to be paid out and the internal-winning probability of a small winning combination in a general game situation is increased (e.g., in the general game situation, the internal-winning probability of “watermelon” is 356/16384, the number of coins to be paid out is 15; the internal-winning probability of “bell” is 7688/16384, the number of coins to be paid out is 6), whereby coin holding during the general is improved. On the contrary, the internal-winning probability of “BB” is set at 38/16384, and the payout rate in total is set to be converged into a fixed value.

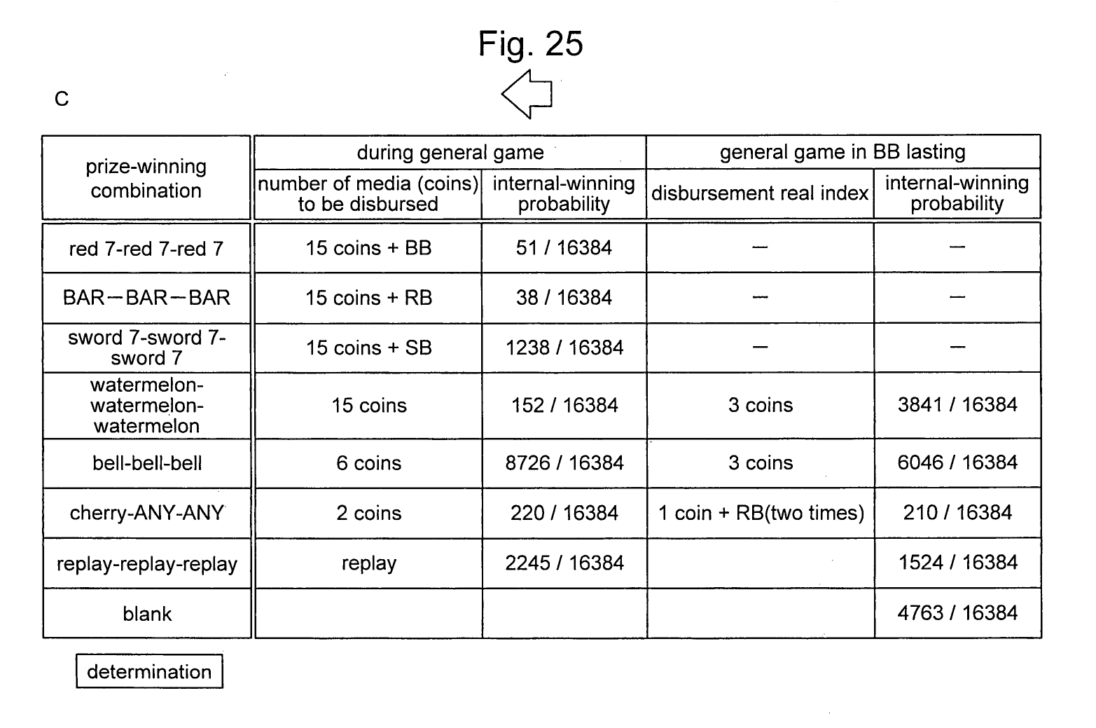

FIG. 25 is a view showing a payout-rate setting screen C. In the setting screen C, the internal-winning probability of “bell” during a general game is increased, thereby player's coins are not spoiled easily. On the contrary, the number of RB games playable during BB is lessened from three to two, and the payout rate in total is set to be converged into a fixed value.

The characteristic of the game can be changed by selecting one from among the plurality of kinds of payout-rate setting screens in this way, and, in order to further adjust the details of the characteristic of the game, the structure can be formed so that each value in the payout-rate setting screen can be changed.

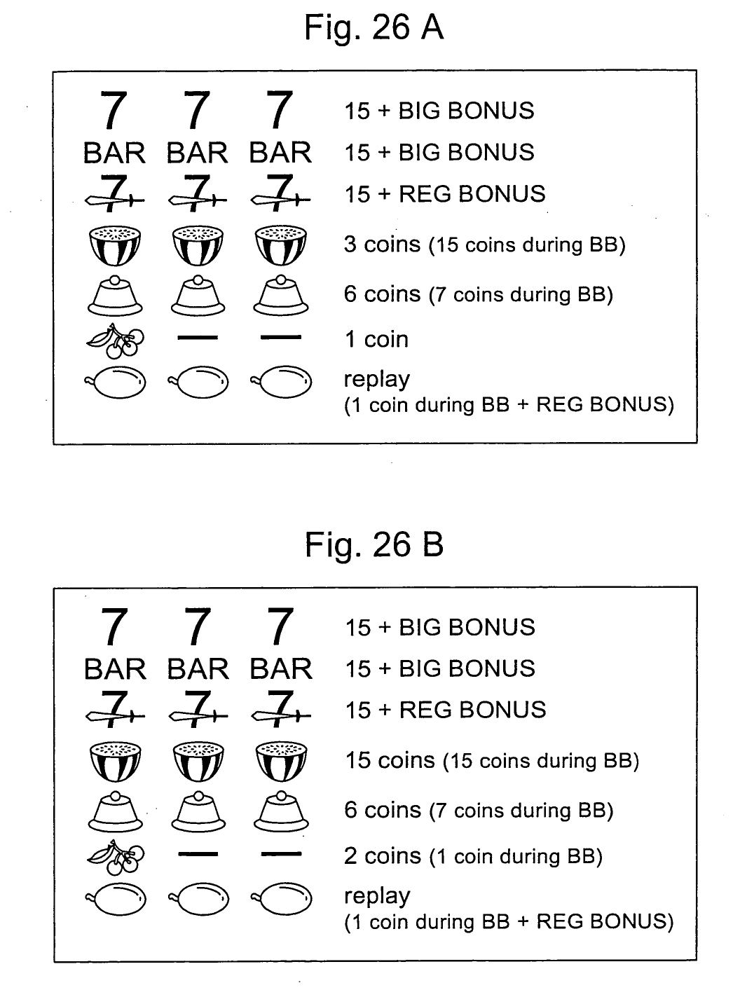

FIG. 26A and FIG. 26B are views showing a payout table displayed on the upper display panel 6. In this embodiment, the structure is formed so that the number of media to be paid out and the internal-winning probability with respect to each winning combination can be changed as mentioned above, and the payout table is controlled and displayed in accordance with set parameters. FIG. 26A is a view showing a payout table displayed when setting is performed in accordance with the contents of the payout-rate setting screen A shown in FIG. 23.

FIG. 26B is a view showing a payout table displayed when setting is performed in accordance with the contents of the payout-rate setting screen B shown in FIG. 24. From this, it is understood that, for example, the number of media to be paid out for “watermelon” during a general game is changed from “3” to “15,” and the number of media to be paid out for “cherry” is changed from “1” to “2,” in comparison with the payout table shown in FIG. 26A.

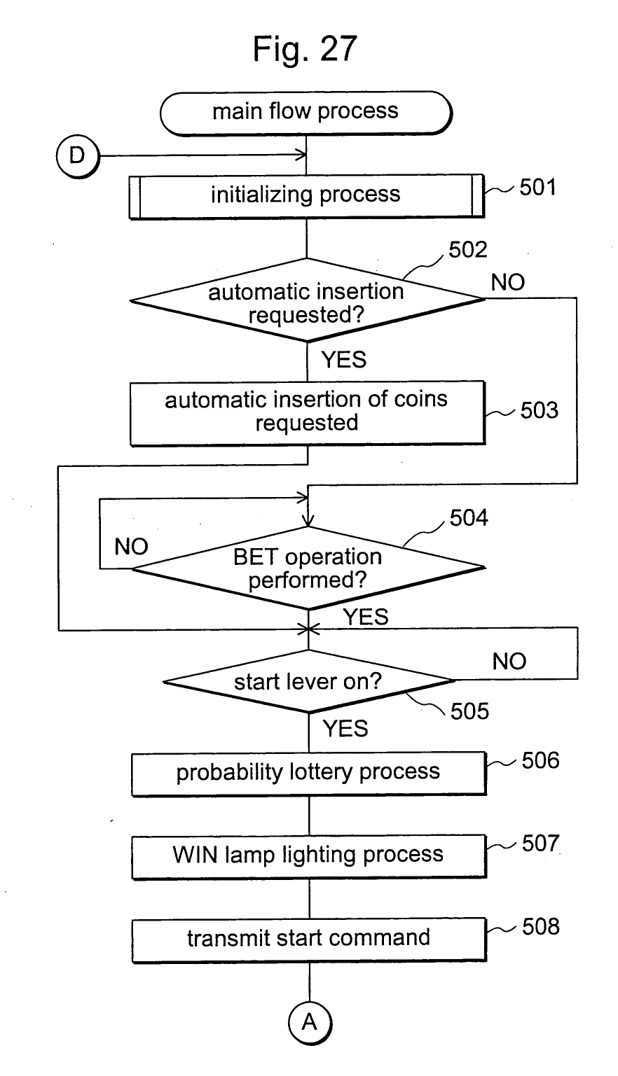

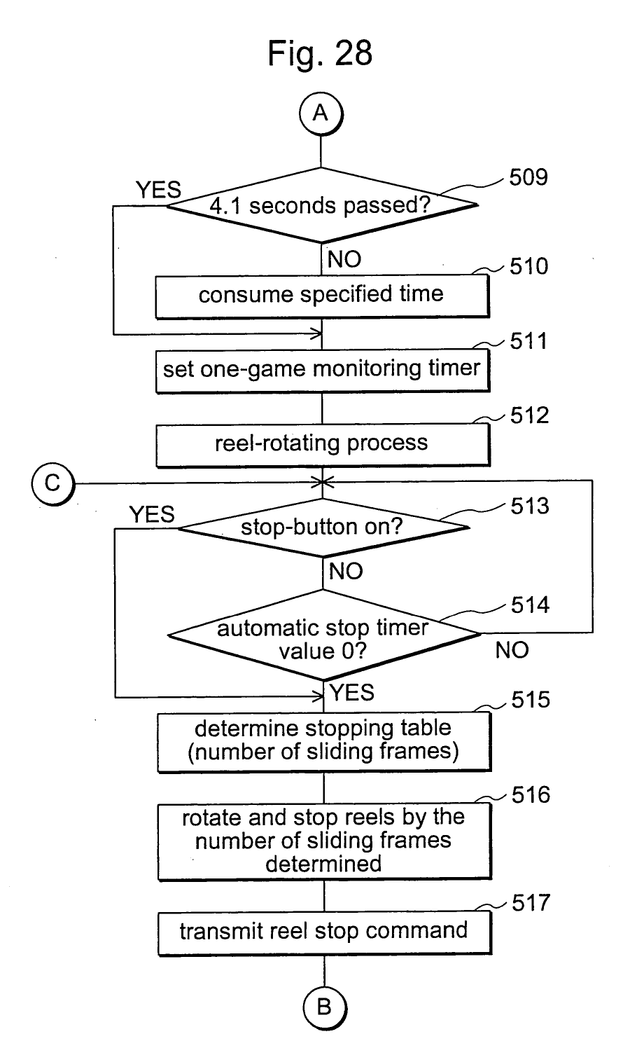

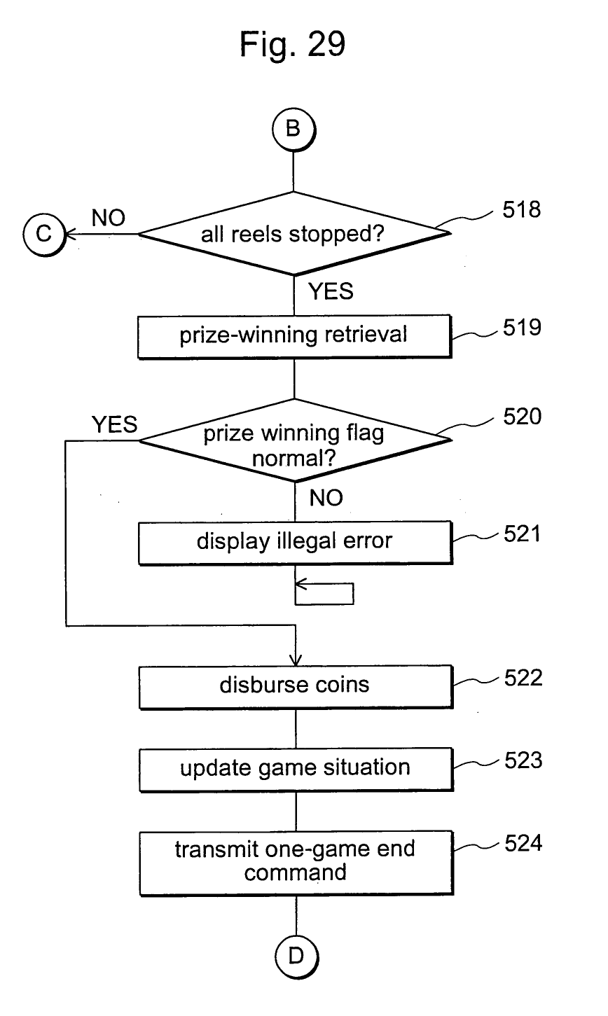

Next, a description will be given of the control operation of the main control circuit 101 and the CPU 103 with reference to main processes shown in FIG. 27 to FIG. 29.

First, the CPU 103 performs an initializing process before a game is started (step 501; hereinafter, “step” is abbreviated as “S”). Before starting up the support menu screen and activating the pachi-slot gaming machine 1, the initializing process is performed to change the amount of media (e.g., the number of coins) to be paid out and the internal probability. The details of this will be described later.

Thereafter, the CPU 103 determines whether coins have been required to be automatically inserted, i.e., whether a “replay” prize was won in the last game (S502). If determined as “YES,” coins required to be inserted are automatically inserted (S503), and the step shifts to the process of S505. If determined as “NO” in S502, a determination is made as to whether coins have been newly inserted, i.e., whether input has been performed from the inserted-coin sensor 117 caused by a player inserting coins through the coin insertion slot 11 and the input caused by operating the BET switches 8, 9, 10 (S504). If determined as “YES” in S504, the step shifts to S505, and, if determined as “NO,” an input signal continues to be monitored until a BET operation is performed.

Thereafter, the CPU 103 determines whether input has been performed by operating the start lever 13 (S505). If determined as “YES,” the step shifts to S506, and, if determined as “NO,” an input signal continues to be monitored until the start lever 13 is operated.

Thereafter, a probability lottery process is performed (S506). In the probability lottery process, a random-number value for a lottery is first extracted within the range of “0 to 16383” by use of the random-number generator 108 and the sampling circuit 109. Thereafter, a determination is made as to a winning range to which an extracted random-number value belongs, and a corresponding internal-winning combination (i.e., winning flag) is determined by use of the winning probability table (FIG. 12) that sets a random-number-value range (i.e., winning range) in which a prize is won in accordance with a game situation and the number of inserted medals. The function of a lottery means is realized by the process of S506.

Thereafter, a WIN lamp lighting process is performed (S507). The WIN lamp lighting process is a process in which a determination and execution are made as to whether the WIN lamp 32 that lights with a fixed probability is lit when a bonus winning combination has obtained internal winning.

Thereafter, the game information of the main control circuit 101 at the start of a game is transmitted to the sub-control circuit (S508). As examples of commands to be transmitted, there are a winning flag determined by the aforementioned probability lottery process and a stopping table number determined in accordance with the present game situation and a winning flag, as shown in “Start command” of the game information command of FIG. 13.

Thereafter, a determination is made as to whether a one-game monitoring timer that has been set in the last game has had a lapse of a predetermined period of time, e.g., 4.1 seconds (S509). If determined as “YES,” the one-game monitoring timer is set for the next game (S511), and, if determined as “NO,” the one-game monitoring timer is set for the next game (S511) after the remaining specific time is consumed (S510).

Thereafter, the CPU 103 controls the motor driving circuit 111 and performs a process (reel-rotating process) to rotate the reels 24L, 24C, and 24R (S512). The reel-rotating process is performed such that an acceleration process is performed from a state in which the reels 24L, 24C, and 24R are being stopped, and, after each of the reels reaches a certain speed, a constant-rotation process is performed. Under the condition where the reels have reached the constant-rotation state, the stop buttons 15L, 15C, and 15R are made effective so that the reels 24L, 24C, and 24R can be operated and stopped.

Thereafter, the CPU 103 determines whether any one of the stop buttons 15L, 15C and 15R has been operated (whether the stop button is on), i.e., determines the presence or absence of a stop signal sent from the reel-stopping signal circuit 118 when a player operates the stop buttons 15L, 15C, and 15R (S513). If determined as “YES,” the step proceeds to S515, and, if determined as “NO,” the step proceeds to S514. In the process of S514, a determination is made as to whether the value of an automatic stop timer is “0.” The automatic stop process is to perform automatic stopping control even if the reels 24L, 24C, and 24R are rotating without operating the stop buttons 15L, 15C, and 15R when a fixed period of time (e.g., 40 seconds) passes since the reels start rotating. If determined as “YES,” i.e., if the automatic stop timer is “0,” the step proceeds to S515 to automatically stop the reels, and, if determined as “NO,” the step proceeds to S513 to continue monitoring the reception of the stopping operation.

In the process of S515, the CPU 103 performs “sliding-segment-number determining process.” In the “sliding-segment-number determining process,” the number of sliding segments of the reel is determined corresponding to the stop button subjected to a stopping operation. The term “sliding-segment-number” denotes the number of symbols (segments) to be slid from the position (designated as “stopping operation position”) of a symbol displayed on each display window 43L, 43C, 43R when the stop buttons 15L, 15C, and 15R have been operated, and the reel is stopped when the number of symbols to be slid is reached (the position where the reel is actually stopped is designated as “stop position”).

Thereafter, the CPU 103 controls the motor driving circuit 111 so that the reel corresponding to the stop button subjected to a stop operation is rotated and stopped when a predetermined sliding-segment-number is reached (S516). The function of the stopping control means is realized by the processes of S515 and S516.

Thereafter, the CPU 103 transmits a “reel stop command” showing that the reel has been stopped to the sub-control circuit 201 (S517). As shown in “Reel stop command” of the game information command, the reel stop command transmits a stop order status (What is the order of the present stopping operation?) and a stop reel status (Which one of the reels has been stopped?) to the sub-control circuit 201.

Thereafter, the CPU 103 determines whether all reels have been stopped. If determined as “YES,” the step proceeds to S519, and, if determined as “NO,” the step proceeds to S513 since a rotating reel still remains.

Thereafter, the CPU 103 performs a winning retrieval process (S519). In this winning retrieval process, a determination is made as to whether the stop mode of a symbol shows that a prize has been won. If the stop mode shows a winning condition, a prize winning flag of the corresponding winning combination is stored in the RAM 105. In detail, a determination is formed by collating the code number of a symbol on the center line L1 with a winning-symbol combination table stored in the ROM 104.

Thereafter, a determination is made as to whether the present prize winning is normal by collating the matching between the prize winning flag and the internal winning flag (S520). If determined as “NO,” an illegal error is displayed, and execution of a game program is discontinued. If determined as “YES” in S520, coins, the number of which is set in accordance with the realized winning combination and the game situation are paid out (S522). The payout device pays out game media in accordance with the number of media to be paid out set to the winning combination.

Thereafter, a shifting process is performed if a game situation is changed because of the end of the present game (S523). For example, there are a case in which it is the final prize winning of a bonus game, a case in which a bonus wins internally during the present game, and a case in which symbols of “7-7-7” are stopped on an pay line and a bonus game starts.

Thereafter, the kind of the realized winning combination, the game situation, etc., are transmitted to the sub-control circuit as a “one-game end command” shown in the command table of FIG. 13 (S524).

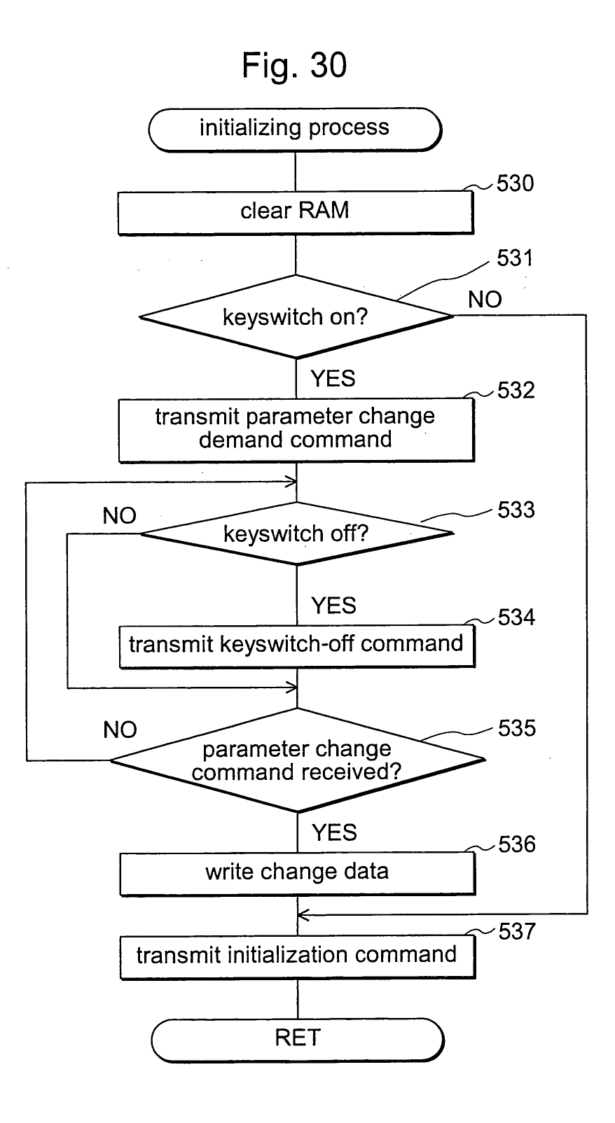

FIG. 30 is a flowchart showing the initializing process. The CPU 103 first performs all clear of the RAM 105 (S530), and then determines whether the keyswitch is on (S531). The keyswitch is a switch that selects whether to execute the parameter changing process in which the number of media to be paid out is changed or the internal-winning probability is changed. If the power source is started up in a state in which the keyswitch is on, the parameter changing process as a payout changing process executed by the sub-control circuit 201 is performed, and, if the power source is started up in a state in which the keyswitch is off, the initialization of the game start is performed without executing the parameter changing process. Therefore, if determined as “YES” in S531, a parameter changing demand command is first transmitted to the sub-control circuit 201 in order to perform the parameter changing process (S532). Thereafter, a determination is made as to whether the keyswitch has been subjected to an off operation (S533), and, if determined as “NO,” an initialization command is transmitted (S537) so as to return to the main process. If determined as “YES” in S533, a keyswitch off command is transmitted to the sub-control circuit 201 to end the parameter changing process (S534). S534 is skipped if determined as “NO.” Thereafter, a determination is made as to whether a parameter change completion command, which shows that the parameter changing process has been ended on the side of the sub-control circuit, has been received or not. If determined as “YES,” a rewriting process of the number of media to be paid out or the winning probability is executed based on the contents of the reception command (S536), and an initialization command is transmitted (S537) so as to return to the main flow. If determined as “NO,” the reception of the command is monitored in S535 because the changing operation is still being performed.

Next, a description will be given of the control operation of the sub-CPU 203 of the sub-control circuit 201.

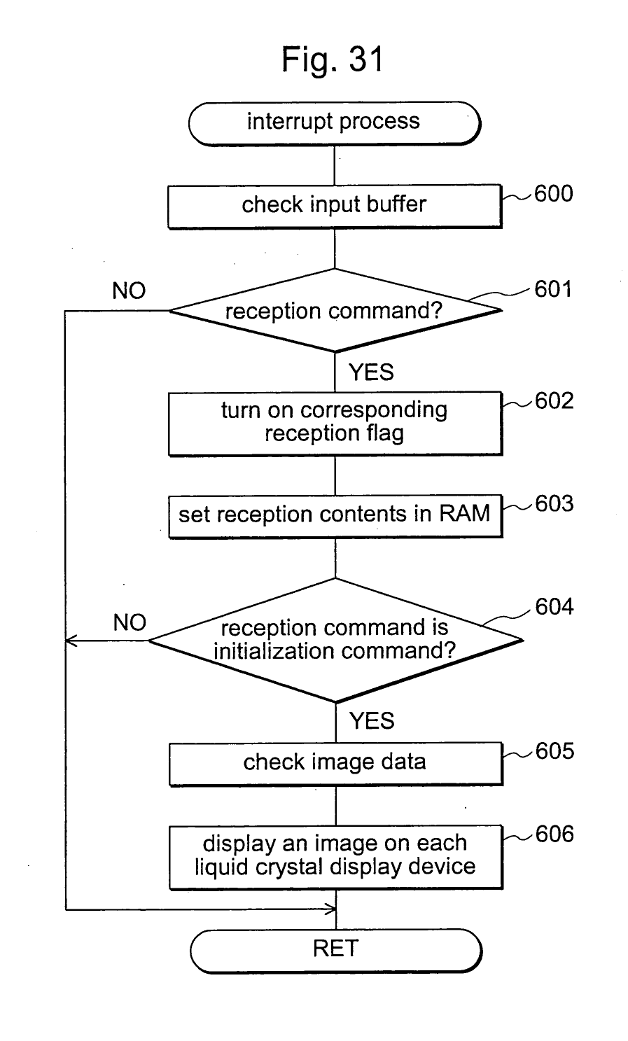

FIG. 31 is a flowchart showing an interrupt process 1. The interrupt process 1 is executed by an interruption every 3 mS, and a command transmitted from the main control circuit 101 is stored in the sub-RAM 205.

The sub-CPU 203 first checks an input buffer (S600), and determines whether the input buffer has an input signal (S601). If determined as “NO,” the process is ended. If determined as “YES,” the reception flag is turned on (S602), and the contents of a reception command are set in the sub-RAM 205 (S603), and the process is ended. Thereafter, the reception command is checked, and a determination is made as to whether the reception command is an initialization command (S604). If determined as “YES,” the applied payout rate setting and the image data based thereon are checked (S605), and an image is displayed on each liquid crystal display device (S606), and the process is ended. If determined as “NO,” the process is ended.

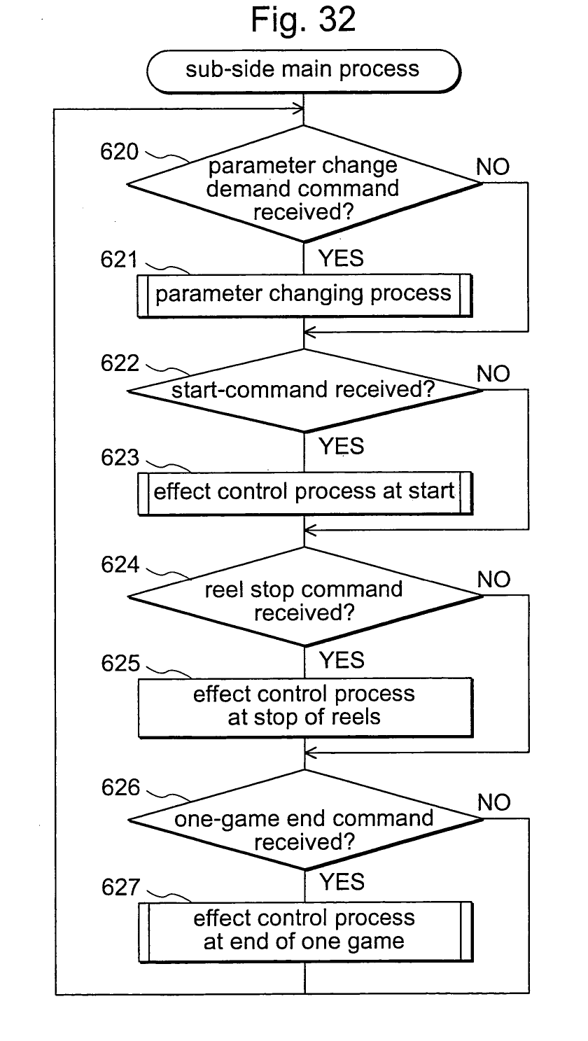

FIG. 32 is a flowchart showing the main process on the side of the sub-control circuit 201. The sub-CPU 203 first checks the reception flag of the sub-RAM 205 and determines whether a parameter change demand command has been transmitted from the main control circuit 101 (S620). If determined as “YES,” the parameter changing process is executed (S621), and the step proceeds to S622. If determined as “NO,” S621 is skipped. The parameter changing process is executed to change the number of media to be paid out or the probability. The details will be described later.

Thereafter, a determination is made as to whether a start command has been received (S622). If determined as “NO,” S623 is skipped, and the step proceeds to S624. If determined as “YES,” an effect control process at the start is executed (S622). The effect control process at the start is to perform the control process of BR when BR is lasting. The details of this will be described later.

Thereafter, a determination is made as to whether a reel stop command has been received (S624). If determined as “NO,” S626 is skipped, and the step proceeds to S625. If determined as “YES,” an effect control process at the reel stop is executed (S625). The effect control process at the reel stop is to perform a notification of a BR generation lottery process or a stop order in the lasting BR and to perform an effect in accordance with consistency between the contents of the notification and an actual stopping operation. The details of this will be described later.

Thereafter, a determination is made as to whether a one-game end command has been received or not (S626). If determined as “NO,” S627 is skipped to return to the process of S620, and the same process is repeatedly operated. If determined as “YES,” an effect control process for the time when one game is ended is executed (S627). The effect control process for the time when one game is ended is to perform a prediction effect process or an updating process of a BR continuation number when BR is lasting. The details will be described later.

After the process of S627 is ended, the step returns to S620, and the same process is repeatedly performed. The main process of the sub-control circuit 201 is to repeatedly perform a process for branching into corresponding effect processes based on a command transmitted from the main control circuit 101 in this way.

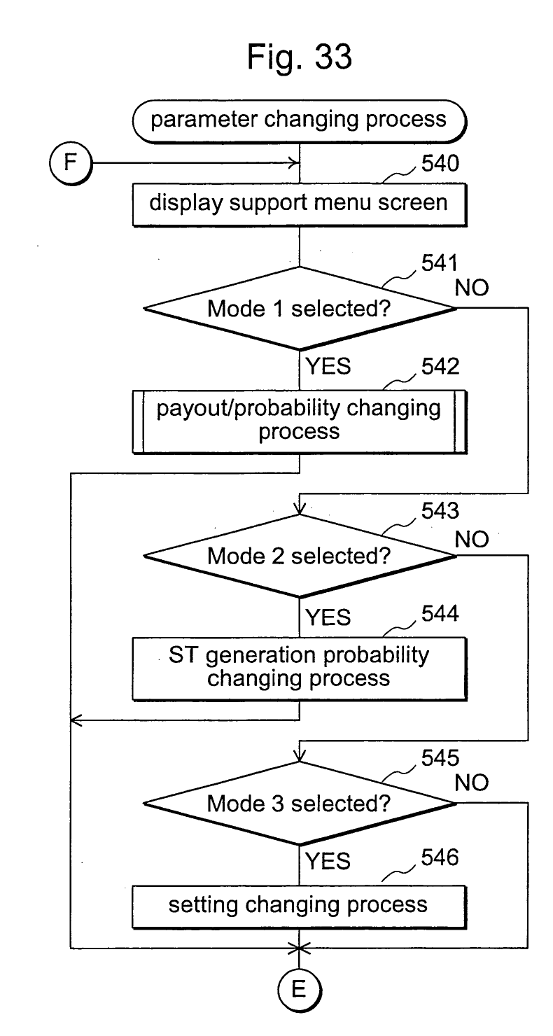

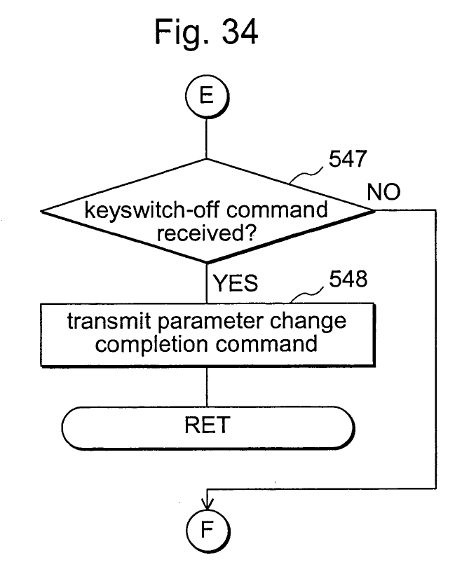

FIG. 33 is a flowchart showing the parameter changing process. The CPU 103 first displays the support menu screen of FIG. 22A (S540). In the support menu, any one of the three modes can be selected. The sub-CPU 203 first determines whether Mode 1 has been selected (S541). If determined as “YES,” a payout/probability changing process is executed (S542), and the step proceeds to S547. If determined as “NO,” a determination is made as to whether Mode 2 has been next selected (S543). If determined as “YES,” a super-time-generation probability changing process is executed (S544), and the step proceeds to S547. If determined as “NO,” a determination is made as to whether Mode 3 has been next selected (S545), and if determined as “YES,” a setting change process is executed, and the step proceeds to S547. If determined as “NO,” no mode is executed, and the step proceeds to S547.

Thereafter, a determination is made as to whether the keyswitch has been turned off, i.e., whether a keyswitch-off command sent from the main control circuit 101 has been received (S547). If determined as “YES,” data concerning the number of media to be paid out and data concerning the probability stored at present are transmitted as parameter-change-completion commands to the main control circuit 101 (S548), and the support menu is ended to return to the initializing process. If determined as “NO,” the step returns to S540, and the same process is repeatedly performed until the selection input of any one of the modes or the operation input of the keyswitch is received.

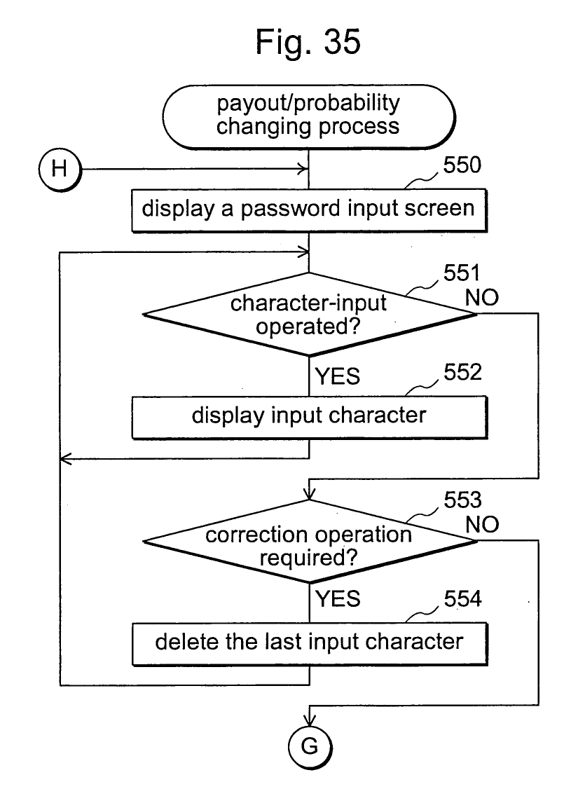

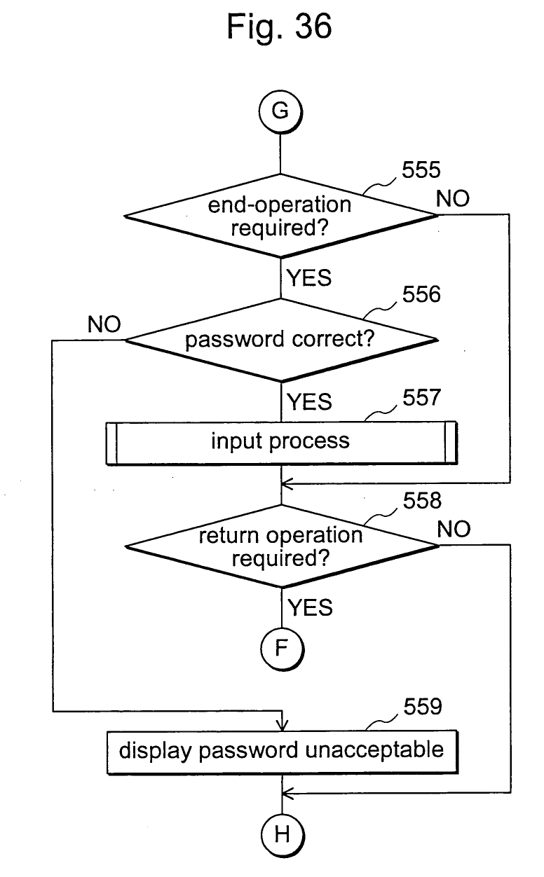

FIG. 35 is a flowchart showing the payout/probability changing process. The CPU 103 first displays the password input screen of FIG. 22B (S550). Thereafter, a determination is made as to whether characters have been inputted by use of a pseudo-keyboard displayed on the screen (S551). If determined as “YES,” a corresponding input character is displayed on an input-character display part of FIG. 22B (herein, the character is displayed as a blank character) (S552), and the step returns to S551. If determined as “NO,” a determination is made as to whether a correction at the lower right of the pseudo-keyboard has been made after that (S553). If determined as “YES,” a character inputted last time is deleted (S554), and the step returns to S551.

If determined as “NO” in S553, a next determination is made as to whether the “END” at the lower right of the pseudo-keyboard has been operated (S555), and, if determined as “YES,” a next determination is made as to whether the password inputted and decided is correct (S556). If determined as “YES,” an input process is next executed (S557). If determined as “NO” in S556, a message to the effect that the password was improper is displayed (S559) by an understanding that an incorrect password has been inputted, and the step returns to S550 to be urged to input a password again.

If determined as “NO” in S555, a next determination is made as to whether the “RETURN” at the lower right of the password-input screen of FIG. 22(b) has been operated (S558). If determined as “YES,” the step returns to S540 that is a step to start a parameter changing process, and, if determined as “NO,” the step returns to S550.

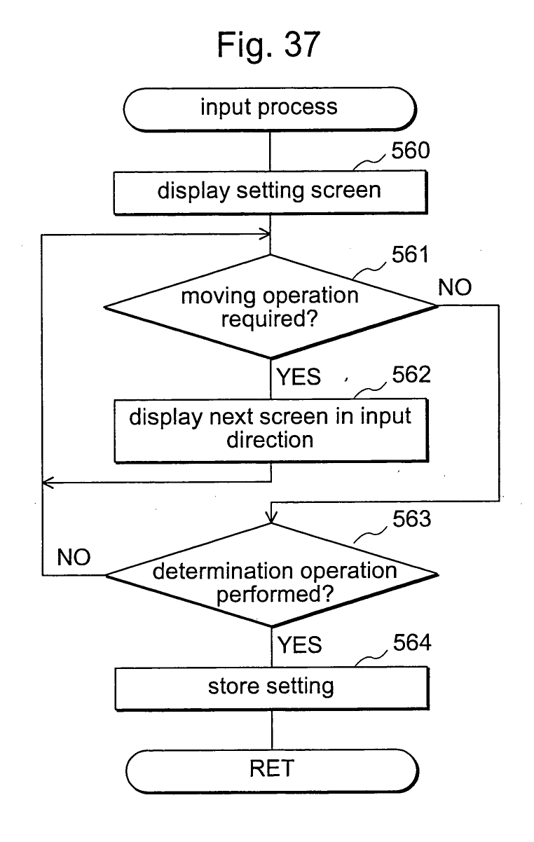

FIG. 37 is a flowchart showing the input process. The CPU 103 first displays the payout setting screen A of FIG. 23 as an initialization screen (S560). The payout setting screen A is one of a plurality of pieces of preset payout and provability data and shows a winning combination, the number of media to be paid out, and probability of internal winning corresponding with this combination. Thereafter, a determination is made as to whether the screen changing button at the upper part of the payout-rate setting screen has been operated (S561). If determined as “YES,” a payout-rate setting screen that is another kind of payout and provability data corresponding to an input operation is displayed (S562), and the step returns to S561. If determined as “NO,” a next determination is made as to whether a “DETERMINATION” button displayed at the lower left of the payout-rate setting screen has been operated (S563). If determined as “YES,” the payout rate displayed at present is stored (S564), and the step returns to the payout/probability changing process. In other words, one piece of payout and provability data is applied in accordance with a selecting operation, and, as a result, the number of media to be paid out, provided for a winning combination is changed. On the other hand, if determined as “NO,” the step returns to S561 to wait for a next input. The process of the media-number changing means is executed according to the aforementioned steps of S550 to S564. The process of the authentication means that authenticates the effectiveness of a password to be inputted is realized by the steps of S550 to S559 among the processes of the payout changing means. A change in the amount of media to be paid out by the payout changing means is determined in accordance with a result of the authentication of this authentication means.

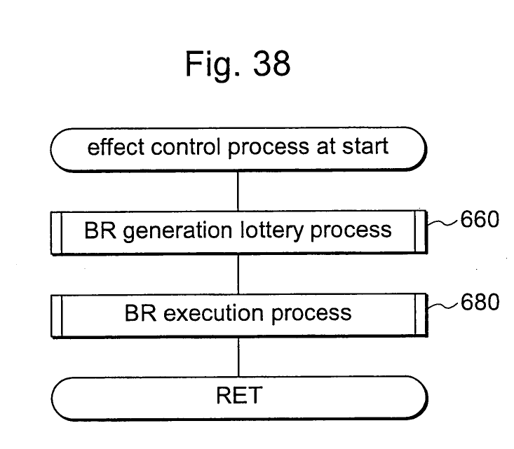

FIG. 38 is a flowchart showing the effect control process at the start. The sub-CPU 203 first performs a BR generation lottery process (S660). The BR generation lottery process is a process to determine whether a battle rush that is a special game is generated. The details of this will be described later. Thereafter, a BR execution process is performed (S680). The BR execution process is to make a stop order notification while BR is lasting. The details of this will be described later.

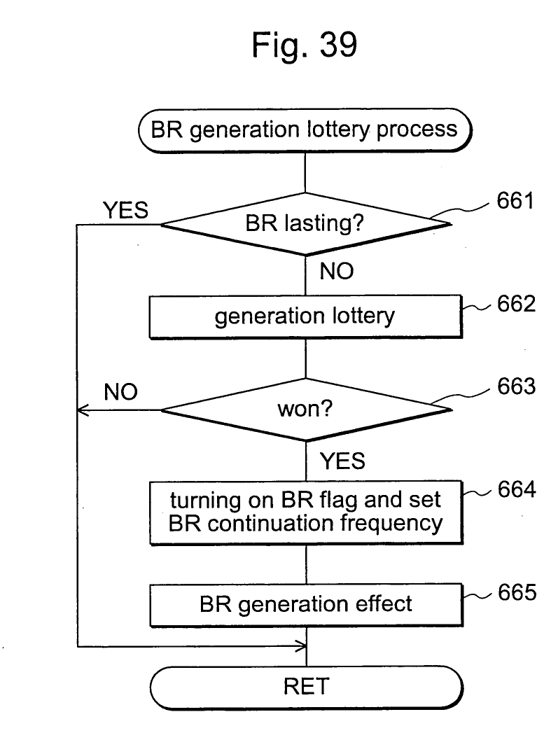

FIG. 39 is a flowchart showing the BR generation lottery process. The sub-CPU 203 first checks the BR flag stored in the sub-RAM 205, and determines whether a BR game is being played at present (S661). If determined as “YES,” the step returns to the effect control process at the start. If determined as “NO,” a determination is made as to whether any one of the BR continuation frequencies has been won (S662, 663) with reference to the BR generation/BR continuation number lottery table of FIG. 20. If determined as “NO” (loss), the step returns to the effect control process at the start. If determined as “YES,” the BR flag of the sub-RAM 205 is turned on, and the continuation number that has won the BR continuation number is set (S664). Thereafter, the BR generation effect is performed (S665), and the step returns to the effect control process at the start.

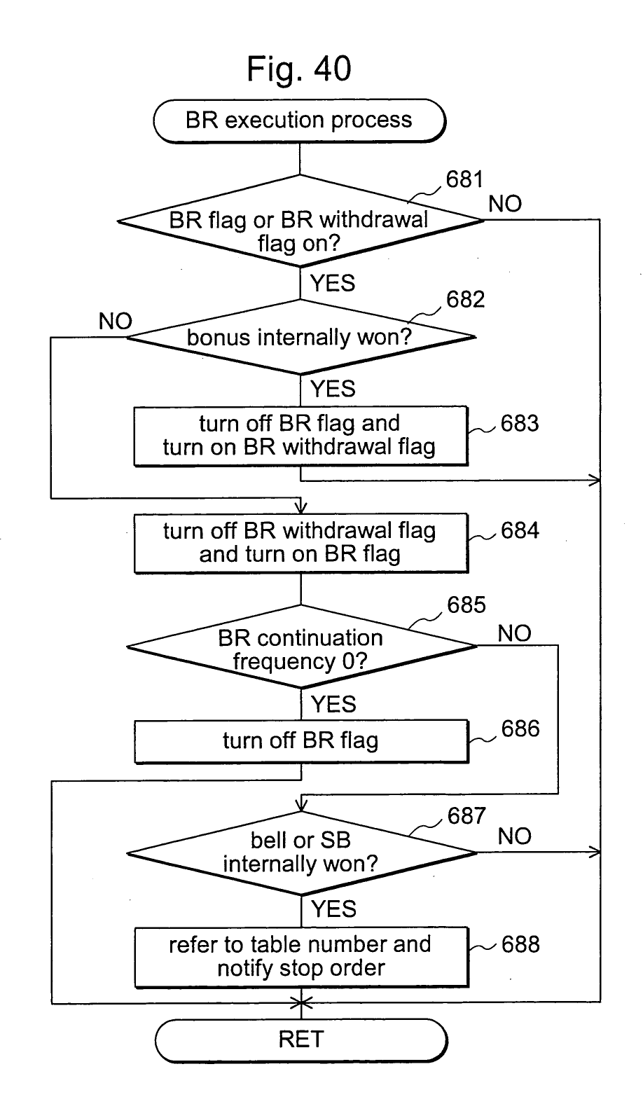

FIG. 40 is a flowchart showing the BR execution process. The sub-CPU 203 first checks the BR flag and the BR withdrawal flag stored in the sub-RAM 205, and determines whether BR is lasting at present or whether BR is being temporarily stopped because a bonus is generated during BR (S681). If determined as “NO,” the step returns to the effect control process at the start as it is, because BR is not lasting. If determined as “YES,” a next determination is made as to whether, by checking the reception flag of the sub-RAM 205, a bonus winning combination has been internally won (S682). If determined as “YES,” BR is stopped, and, in order to complete the bonus game, the BR flag of the sub-RAM 205 is turned off, and the BR withdrawal flag is turned on (S683), and the step returns to the effect control process at the start.

If determined as “NO” in S682, in order to replay BR when BR is in a withdrawal state, the BR withdrawal flag of the sub-RAM 205 is turned off, and the BR flag is turned on (S684). Thereafter, in order to check whether all of the BR continuation number have been used, the BR continuation number of the sub-RAM 205 is checked, and a determination is made as to whether the continuation number reaches 0 (zero) (S685). If determined as “YES,” the BR flag is turned off from the fact that BR has been ended (S686), and the step returns to the effect control process at the start.

If determined as “NO,” the reception flag of the sub-RAM 205 is then checked from the fact that a regular number of BR games have not yet completed, and a determination is made as to whether bell or SB has been internally won during the present game (S687). If determined as “YES,” an appropriate stop order is notified with reference to a selected stopping-table kind stored in the reception flag of the sub-RAM 205 (S688), and the step returns to the effect control process at the start. If determined as “NO,” the step returns to the effect control process at the start without any notification.

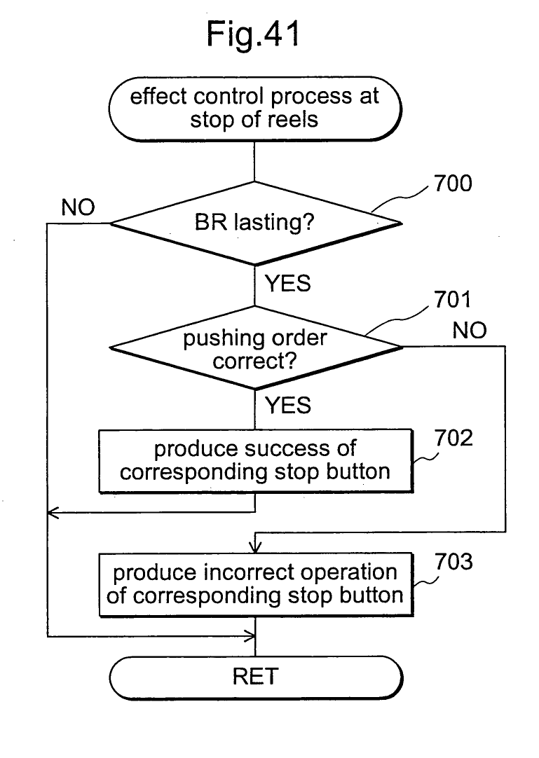

Next, a description will be given of the effect control process performed when the stop buttons 15L, 15C, and 15R are operated while BR is lasting. FIG. 41 is a flowchart showing the effect control process performed when the reels are stopped. The sub-CPU 203 first checks the BR flag of the sub-RAM 205, and determines whether BR is lasting at present (S700). If determined as “NO,” the step returns to the sub-side main process as it is. If determined as “YES,” a stop command of the reception flag of the sub-RAM 205 is then checked, and stop-order data and stop-reel data are collated with to-be-used table No. data, and a determination is made as to whether the present stopping operation has been performed in appropriate pushing order according to the order specified by the stopping table (S701). If determined as “YES,” a message to the effect that the buttons have been pushed and operated in correct pushing order is displayed (S702). If determined as “NO,” a message to the effect that the buttons have been pushed and operated in incorrect pushing order is displayed (S703), and the step returns to the sub-side main flow.

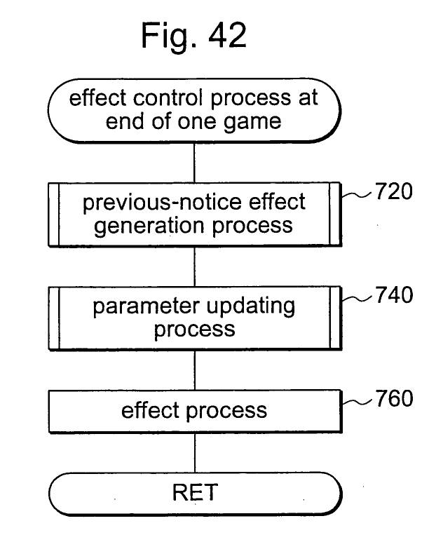

Next, a description will be given of the effect control process performed after all of the reels are stopped. FIG. 42 is a flowchart showing the effect control process performed when one game is ended. The sub-CPU 203 first executes a prediction effect generation process that determines whether the prediction effect of an internal-winning combination is generated (S720). Thereafter, when the present game situation is in the state of BR, a parameter updating process by which related parameters are updated is executed (S740). Thereafter, when the generation of the prediction effect is determined by the prediction effect generation process, the effect process is executed (S760), and the step returns to the sub-side main process.

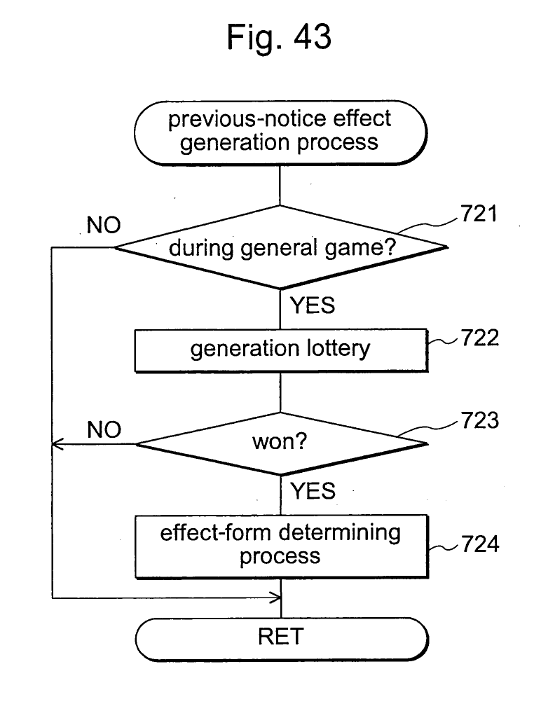

FIG. 43 is a flowchart showing the prediction effect generation process. The sub-CPU 203 first checks the reception flag of the sub-RAM 205, and determines whether the present game situation is during a general game (S721). If determined as “YES,” a generation lottery of the prediction effect is operated with reference to the prediction effect generation table of FIG. 21A (S722). Thereafter, a determination is made as to whether a prize has been won (S723). If determined as “YES,” an effect-form determining process that determines the form of the prediction effect is executed with reference to the effect-kind selection table of FIG. 21B (S724), and the step returns to the effect control process performed when one game is ended. If determined as “NO,” the step directly returns to the effect control process performed when one game is ended.

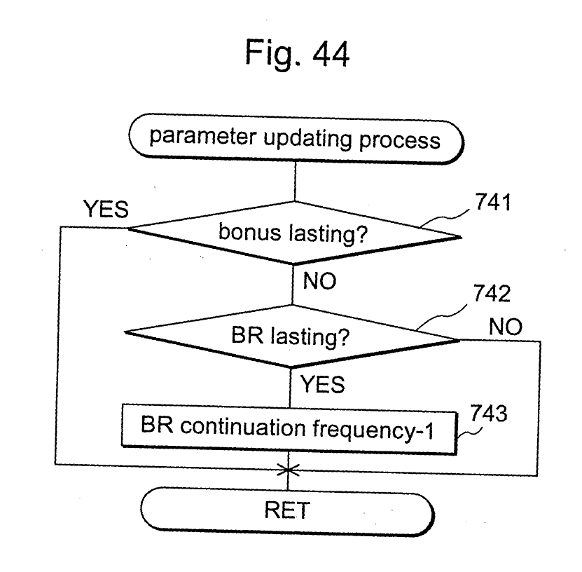

FIG. 44 is a flowchart showing the parameter updating process. The sub-CPU 203 first checks the one-game end command of the reception flag stored in the sub-RAM 205, and determines whether the present game situation is during a bonus game (S741). If determined as “YES,” the step directly returns to the effect control process of the one-game end, because BR is never lasting. If determined as “NO,” the BR flag stored in the sub-RAM 205 is then checked, and a determination is made as to whether BR is lasting at present (S742). If determined as “NO,” the step directly returns to the effect control process of the one-game end. If determined as “YES,” the BR continuation number counter of the sub-RAM 205 is subjected to a subtraction operation (S743), and the step returns to the effect control process of the one-game end.

In this embodiment, a description has been provided using the super time period that is a situation advantageous to a player. However, as a situation advantageous to the aforementioned AT and to, the player, another winning flag of a specific winning combination may be established, or the internal-winning probability of the winning combination may be increased.

In this embodiment, a description has been provided using the payout of coins as an example. However, the present invention is applicable to a gaming machine using various type of game medium, for example a token, coupon, magnetic card storing gaming data and combination thereof.

Besides the pachi-slot machine with stop buttons described in the embodiment, the present invention is applicable to a slot machine which does not have stop buttons The stopping control means of the slot machine is performed in the CPU and control circuit by measuring timing for reel stopping.

Further, besides the pachi-slot machine described in the embodiment, the present invention is applicable also to a pachinko gaming machine including an electric display device, to an arcade gaming machine, and to a domestic game in which the aforementioned functions are performed on software in a pseudo manner.

According to the aforementioned structure, it is possible to solve the problem of dead stock resulting from the fact that a physical acrylic plate and a symbol cell sheet are used in a display panel and the problem of an increase in the number of assembly steps. Further, since the structure is formed such that the amount of payout for a winning combination can be changed afterward, a flexible change in accordance with the business policy of a center can be made.

What is claimed is:

1. A gaming machine comprising:
a plurality of reels for variably displaying each of a plurality of symbols thereon;
an image display device for displaying an image that differs from the symbols of the reels;
a payout device for payout;
a controller for executing a predetermined program and controls the reels, the image display device, and the payout device,
wherein the controller operates a lottery of a winning combination according to the predetermined program;
the controller controls and stops a changing display of the reel based on the winning combination obtained by the lottery;
the controller allows the payout on the basis of an amount of payout set to the winning combination when a stop mode of the reel matches a symbol combination of the winning combination; and
the controller allows the image display device to display the winning combination and an amount of payout while changing the amount of payout.

2. The gaming machine according to claim 1, wherein the image display device is formed by an electric display device and displays an image with reference to the amount of payout.

3. The gaming machine according to claim 1, wherein the controller operates in a plurality of operating modes for changing the amount of payout.

4. The gaming machine according to claim 3, wherein at least one of the operating modes changes a probability of the lottery.

5. The gaming machine according to claim 4, wherein at least one of the operating modes changes the probability of the lottery for a bonus winning combination.

6. The gaming machine according to claim 1, wherein the controller has a plurality of kinds of payout data, and applies one kind of the payout data based on a selecting operation of a manager for managing the gaming machine.

7. The gaming machine according to claim 1, wherein the controller also authenticates effectiveness of a password inputted by an operation of a manager for managing the gaming machine, and changing the amount of payout on the basis of a result of the authentication means.

8. A gaming machine comprising:
variable display means for variably displaying a plurality of symbols;
lottery means for operating a lottery of a winning combination;
stopping control means for controlling and stopping the variable display means on a basis of a result of the lottery;
payout means for payout on the basis of an amount of the payout set for the winning combination when a stopped state of the variable display means reaches a symbol combination equal to the winning combination;
payout display means for displaying the winning combination and at least the amount of payout to be paid out; and
payout changing means for changing the amount of payout.
